(19) United States
(12) Patent Application Publication
(10) Pub. No.: US 2025/0077797 A1
(43) Pub. Date: Mar. 6, 2025

(54) AI-ASSISTED U.S. VETERAN WRITING SYSTEM

(71) Applicant: Alex K. Sebby, Quantico, VA (US)

(72) Inventor: Alex K. Sebby, Quantico, VA (US)

(21) Appl. No.: 18/818,962

(22) Filed: Aug. 29, 2024

Related U.S. Application Data
(60) Provisional application No. 63/580,100, filed on Sep. 1, 2023.

(51) Int. Cl. G06F 40/40

(52) U.S. Cl. CPC G06F 40/40

(57) ABSTRACT

An AI-assisted Veteran writing platform system provides writing prompt modules and/or questions to which a user can provide responses. An artificial intelligence (AI) widget can be included that assists the user in responding to the questions. The system can consolidate questions and answers and generate a story/blog post based on the consolidated questions and responses. The individual responses or the consolidated questions and responses may be emailed to recipients. The system allows for the user to access the AI widget to assist the user in answering the questions. The AI-assisted Veteran writing platform system is private, can be done from a convenient location and at a convenient time for the user, and assists Veterans in writing about their military experiences.

### CROSS REFERENCE TO RELATED APPLICATIONS

This application claims priority under 35 U.S.C. § 119 to provisional patent application U.S. Ser. No. 63/580,100, filed Sep. 1, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to apparatus(es), system(s), and/or method(s) having applications in at least the Information Technology (IT), data processing, artificial intelligence (AI), and/or writing assistance industries. More particularly, but not exclusively, the present disclosure relates to apparatus(es), system(s), and/or method(s) that utilize AI and/or word processing in an AI-assisted writing platform.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Military Veterans often face extreme difficulties after completing their service. Many Veterans face challenges relating to trauma and grief associated with their military service. Such challenges can manifest themselves in different ways. For example, many Veterans suffer from post-traumatic stress disorder (PTSD) that has developed due to trauma experienced during their service. Additionally, Veterans often face other mental health struggles. Writing about such traumatic experiences can often help alleviate mental health struggles and can lead to positive effects in terms of the mental health of Veterans. Additionally, writing about their military service can help Veterans make sense of their service and can be therapeutic. Additionally, it can also be therapeutic for Veterans to read about the experiences of other Veterans.

Military Veterans often desire to write about their military experience. However, Veterans often encounter difficulty when attempting to write about such military experience. Currently available writing services geared toward U.S. Veterans typically require the U.S. Veteran to leave the comfort of their home, require the U.S. Veteran to be physically at the location of the provider, and do not allow the U.S. Veteran to operate on their own schedule. Thus, currently available writing services for Veterans lack accessibility. Currently available writing services for Veterans also often lack any sort of emotional support and often lack privacy.

Further, currently available writing platforms lack the use of AI to assist a user in completing the writing platform and in telling a story. Thus, currently available writing platforms often require outside research in order to complete the platform and/or to tell a story. Such outside research can be cumbersome, expensive, and time-consuming. Additionally, without AI assistance, the quality of stories written by inexperienced writers and/or writers that are not tech-savvy often suffers.

Additionally, Veterans who write about their experiences often find it difficult to publish their writings generally and/or find it difficult to publish their writings wherein such writings can reach a large audience. Thus, any benefits, such as therapeutic benefits, that Veterans may obtain by reading about the experiences of other Veterans is limited by the fact that Veterans' writings often are not published and/or are not published in a manner that will reach a large audience.

Additionally, achieving formal recognition of U.S. military service is often a lengthy process, can be bureaucratic, and can be controversial. In fact, formal U.S. military recognition often never occurs for many Veterans.

Thus, there exists a need in the art for a technological solution including an apparatus, system, and/or method which provides a writing platform for Veterans, including U.S. Veterans, wherein the writing platform is private, the platform can be received, accessed, applied, performed, and/or completed at a convenient location for the Veteran, the platform can be received, accessed, applied, performed, and/or completed at any time of convenience for the Veteran, and wherein the platform is effective in assisting Veterans to write about their military experience. There exists a further need in the art for an apparatus, system, and/or method which provides a writing platform that includes assistance via AI capable of conducting fast and effective research such that a user does not need to perform time-consuming, expensive, and cumbersome outside research. There exists a further need in the art for an apparatus, system, and/or method which provides a writing platform that includes assistance via AI capable of increasing the quality of a written product produced via the writing platform. There exists a further need in the art for an apparatus, system, and/or method which provides a writing platform for Veterans wherein the writing platform helps Veterans manage challenges related to their military service, such as mental health struggles which can include, but are not limited to, suicidal thoughts and/or actions, substance usage and/or abuse, PTSD, anger, and the like. There exists a further need in the art for an apparatus, system, and/or method which provides a writing platform for Veterans wherein the writing platform provides emotional support to Veterans. There exists a further need in the art for an apparatus, system, and/or method to easily and quickly publish writing(s) written by a Veteran with AI assistance in a manner wherein the published writing(s) will be available to a large and interested audience and wherein the published writing(s) achieve wide distribution. There exists a further need in the art for an apparatus, system, and/or method to that allows a Veteran to achieve recognition by publishing a story regarding his or her military service.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide an apparatus, system, and/or method capable of providing an AI-assisted writing platform directed primarily to Veterans (or other groups or classes of individuals who have suffered trauma or hardships) wherein said writing platform is private, said platform can be received, accessed, applied, performed, and/or completed at a convenient location for the Veteran, said platform can be received, accessed, applied, performed, and/or completed at any time of convenience for the Veteran, and wherein said platform is effective in assisting Veterans to write about their military experience.

It is a further object, feature, and/or advantage of the present disclosure to provide an apparatus, system, and/or method capable of providing a writing platform that is AI-assisted such that a user can conduct research via the AI assistance and wherein the user does not have to spend time and/or resources performing outside research in order to tell a story.

It is a further object, feature, and/or advantage of the present disclosure to provide an apparatus, system, and/or method capable of providing a writing platform that is AI-assisted such that the AI can increase the quality of a written product produced via the writing platform.

It is a further object, feature, and/or advantage of the present disclosure to provide an apparatus, system, and/or method capable of being implemented via a computing device and capable of being implemented both via a personal computer format and/or via a mobile computing format.

It is a further object, feature, and/or advantage of the present disclosure to provide an apparatus, system, and/or method that provides a writing service for Veterans that helps Veterans manage challenges related to their military service, such as mental health struggles which can include, but are not limited to, suicidal thoughts and/or actions, substance usage and/or abuse issue(s), PTSD, anger, and the like.

It is a further object, feature, and/or advantage of the present disclosure to provide an apparatus, system, and/or method that provides a writing service for Veterans wherein the writing service provides real-time emotional support to Veterans.

It is a further object, feature, and/or advantage of the present disclosure to provide an apparatus, system, and/or method that is capable of easily and quickly publishing and/or distributing a story written by a veteran using AI assistance wherein the published story will be available to a large and interested audience.

It is still yet a further object, feature, and/or advantage of the present disclosure to provide an apparatus, system, and/or method that allows a Veteran to achieve recognition by publishing a story regarding his or her military service.

The apparatus(es), system(s), and/or method(s) disclosed herein can be used in a wide variety of applications. For example, the apparatus(es), system(s), and/or method(s) are capable of operating via a computing device both in a personal computer environment and in a mobile environment. Additionally, while the apparatus(es), system(s), and/or method(s) described herein are often described as being applicable to U.S. Veterans, the disclosed apparatus(es), system(s), and/or method(s) could be applicable to Veterans of any nation and/or jurisdiction.

It can be beneficial that the apparatus(es), system(s), and/or method(s) be safe, private, and cost-effective. For example, any information submitted by a user in conjunction with a disclosed apparatus, system and/or method is confidential and private unless the user authorizes publication of any submitted information. Additionally, the disclosed apparatus(es), system(s), and/or method(s) allow a user to delete his or her account and/or to delete any information previously submitted. Further, the disclosed apparatus(es), system(s), and/or method(s) can reduce and/or eliminate excess resources, including time and money, needed to write a story without the use of the disclosed apparatus(es), system(s), and/or method(s).

Methods can be practiced which facilitate use, manufacture, assembly, maintenance, and repair of any apparatus and/or system described herein which accomplish some or all of the previously stated objectives.

Any apparatus and/or method described herein can be incorporated into systems which accomplish some or all of the previously stated objectives. Additionally, any system described herein can be incorporated into larger designs which accomplish some or all of the previously stated objectives.

According to some aspects of the present disclosure, a system for writing assistance comprises: a processor; a memory unit and/or non-transitory computer-readable medium that stores executable instructions that, when executed by the processor, perform operations, the operations comprising: prompting a user with one or more questions; allowing the user to submit a response to each of the one or more questions; and allowing the user to access an AI widget to perform research in substantially real time to assist in submission of the response(s) to each of the one or more questions.

According to some additional aspects of the present disclosure, the operations further comprise consolidating and providing a consolidated copy of each of the one or more questions and each response to the one or more questions.

According to some additional aspects of the present disclosure, the operations further comprise allowing the user to email the consolidated copy to a customizable email address.

According to some additional aspects of the present disclosure, the operations further comprise: allowing a user to upload the consolidated copy and/or upload a photograph; and providing confirmation of said upload to the user.

According to some additional aspects of the present disclosure, the operations further comprise creating a blog post based on the uploaded consolidated copy and the uploaded photograph.

According to some additional aspects of the present disclosure, the operations further comprise creating a book based on the blog post and/or the consolidated copy.

According to some additional aspects of the present disclosure, the system allows the user to submit a response to each of the one or more questions via text input and/or voice input.

According to some additional aspects of the present disclosure, the AI widget is configured to allow the user to prompt the widget wherein the widget then responds to the user.

According to some other aspects of the present disclosure, a method of providing writing assistance comprises: prompting a user with one or more questions; allowing a user to respond to each of the one or more questions; and allowing the user to access an AI widget to perform research in substantially real time to assist in submission of a response to each of the one or more questions.

According to some additional aspects of the present disclosure, the method is for use primarily by United States military Veterans.

According to some additional aspects of the present disclosure, the method further comprises consolidating and providing a consolidated copy of each of the one or more questions and each response to the one or more questions to the user.

According to some additional aspects of the present disclosure, the method further comprises allowing the user to email the consolidated copy to a specifiable email address.

According to some additional aspects of the present disclosure, the method further comprises: allowing a user to upload the consolidated copy and/or upload a photograph; and providing confirmation of said upload to the user.

According to some additional aspects of the present disclosure, the method further comprises creating a blog post, with AI assistance, based on the uploaded consolidated copy.

According to some additional aspects of the present disclosure, the step of allowing the user to respond to each of the one or more questions can be accomplished by the user via text input and/or voice input.

According to some additional aspects of the present disclosure, the method further comprises allowing the user to create a private, secure, and anonymous account of which the user can login and logout.

According to some additional aspects of the present disclosure, the AI widget is configured to allow the user to prompt the widget wherein the widget then responds to the user.

According to some additional aspects of the present disclosure, the AI widget is configured to provide emotional support and/or advice to the user.

According to some additional aspects of the present disclosure, the method is computer-implemented.

According to some other aspects of the present disclosure, a cyberinfrastructure comprising executable instructions that, when executed by a processor, perform operations, wherein the operations comprise: displaying one or more questions such that the one or more questions are viewable by a user; allowing the user to submit a response to each of the one or more questions; allowing the user to utilize an AI widget to assist in submission of each response to each of the one or more questions; creating a story based on the one or more questions and each response thereof; and publishing the story for access by others.

According to some additional aspects of the present disclosure, the operations further comprise crediting the user as an author of the story.

According to some other aspects of the present disclosure, a computer-implemented method for assisting Veterans, comprises: displaying one or more questions via a display such that the one or more questions are viewable by a user; allowing the user to submit a response to each of the one or more questions; allowing the user to provide input to an AI widget to assist the user in submission of at least one response to at least one of the one or more questions; and providing a therapeutic benefit to the user based on the one or more questions and response(s) thereto and/or based on the user's input to the AI widget.

According to some additional aspects of the present disclosure, the therapeutic benefit comprises recognizing an indication that the user is experiencing and/or has experienced a challenge, based on the response to at least one of the one or more questions and/or on the input provided to the AI widget, and providing output via the AI widget regarding the challenge.

According to some additional aspects of the present disclosure, the challenge comprises suicidal thought(s), PTSD symptom(s), substance usage issue(s), anger, and/or any combination thereof.

According to some additional aspects of the present disclosure, the output comprises guidance, advice, and/or emotional support.

According to some additional aspects of the present disclosure, the guidance, advice, and/or emotional support is related to suicide prevention.

According to some additional aspects of the present disclosure, the therapeutic benefit comprises generating and publishing a story based on the one or more questions and the response(s) thereof.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a view of aspects of an example writing platform system according to aspects of the present disclosure.

FIG. 2 shows a view of aspects of the writing platform system of FIG. 1.

FIG. 3 shows a view of aspects of the writing platform system of FIG. 1 in a mobile format.

FIG. 4 shows a partial view of consolidated questions and responses according to aspects of the writing platform system of FIG. 1.

FIG. 5 shows a partial view of the consolidated questions and responses referenced in FIG. 4 in a mobile format.

FIG. 6 shows a view of an account creation feature according to aspects of the writing platform system of FIG. 1.

FIG. 7 shows a view of a login/sign-in feature according to aspects of the writing platform system of FIG. 1.

FIG. 8 shows a view of an account deletion feature according to aspects of the writing platform system of FIG. 1.

FIG. 9 shows a view of an account update feature according to aspects of the writing platform system of FIG. 1.

FIG. 10 shows a view of a sign up and/or login feature to redeem a voucher according to aspects of the writing platform system of FIG. 1.

FIG. 11 shows a view of a voucher redemption feature according to aspects of the writing platform system of FIG. 1.

FIG. 12 shows a view of an overview feature according to aspects of the writing platform system of FIG. 1.

FIG. 13 shows a view of an instruction feature according to aspects of the writing platform system of FIG. 1.

FIG. 14 shows an upload and story generation feature according to aspects of the writing platform system of FIG. 1.

FIG. 15 shows the upload and story generation feature of FIG. 14 in a mobile format.

FIG. 16A shows a pop-up feature associated with the upload and story generation feature of FIG. 14.

FIG. 16B shows an enlarged view of the pop-up feature of FIG. 16A.

FIG. 17 shows the pop-up feature of FIG. 16A in a mobile format.

FIG. 18 shows a view of an example story generation feature according to aspects of the writing platform system of FIG. 1.

FIGS. 19A-F show several views of a book creation feature according to aspects of the writing platform system of FIG. 1.

FIG. 20 shows a block diagram of a cyberinfrastructure according to aspects of the present disclosure.

An artisan of ordinary skill in the art need not view, within isolated figure(s), the near infinite number of distinct permutations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Unless defined otherwise, all technical and scientific terms used herein have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

The term “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

The terms “invention” or “present invention” are not intended to refer to any single embodiment of the particular invention but encompass all possible embodiments as described in the specification and the claims.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as “constructed”, “arranged”, “adapted”, “manufactured”, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art. For instance, although the disclosure may depict a serial process/method, some of the steps/processes/methods disclosed herein may be performed in parallel or out of sequence or combined into a single step/process/method.

As used herein, the term “exemplary” refers to an example, an instance, or an illustration, and does not indicate a most preferred embodiment unless otherwise stated.

The description is not to be taken in a limiting sense but is made merely for the purpose of illustrating the general principles of the present disclosure.

Broadly, some embodiments of the present disclosure provide an AI-guided system operative to administer a modular writing platform system that is configured to assist Veterans in writing about complex stories.

Some embodiments of the present disclosure help Veterans, which could be U.S. Veterans, write and research their experience. The AI provides assistance and makes writing for Veterans easier and more convenient. The disclosed apparatus(es), method(s), and/or system(s) are private, can be performed from a convenient location for the user (such as from the user's home) and on the user's schedule, and assist Veterans to write about their military experiences. The consolidated answers to the questions of the system(s) and/or method(s) are a great way to help Veterans to develop the ability to write a memoir about their military experience.

The disclosed system(s) and/or method(s) can be integrated with a web server, browser, search engine, and/or any combination thereof and executed by the server, browser, search engine, and/or any combination thereof. Additional services can include Simple Mail Transfer Protocol (SMTP), Messaging Application Programming Interface (MAPI), Internet Message Access Protocol (IMAP), Network File System (NFS), Short Message Service (SMS), IP Multimedia Subsystem (IMS), and/or Structured Query Language (SQL) servers and clients.

The entirety of the disclosed system(s) and/or method(s) may be mobile-friendly. Additionally, the disclosed system(s) and/or method(s) are private and secure. Further, the system(s) and/or method(s) allow a user to use a pseudonym and/or remain anonymous if the user should so choose.

To use the system(s) described herein, a writer may enter text into text fields in response to writing prompts wherein the writer can use an AI chat widget to obtain information and/or emotional support. The AI-assisted Veteran writing platform system(s) can combine the answers of all the AI-assisted U.S. Veteran writing platform system(s) questions to enable Veterans to write a memoir about their military experience.

While the present disclosure describes and discloses apparatus(es), system(s), and method(s), for convenience, the term “system” is used herein to refer to any and/or all aspects of the apparatus(es), system(s), and/or method(s) described and disclosed herein.

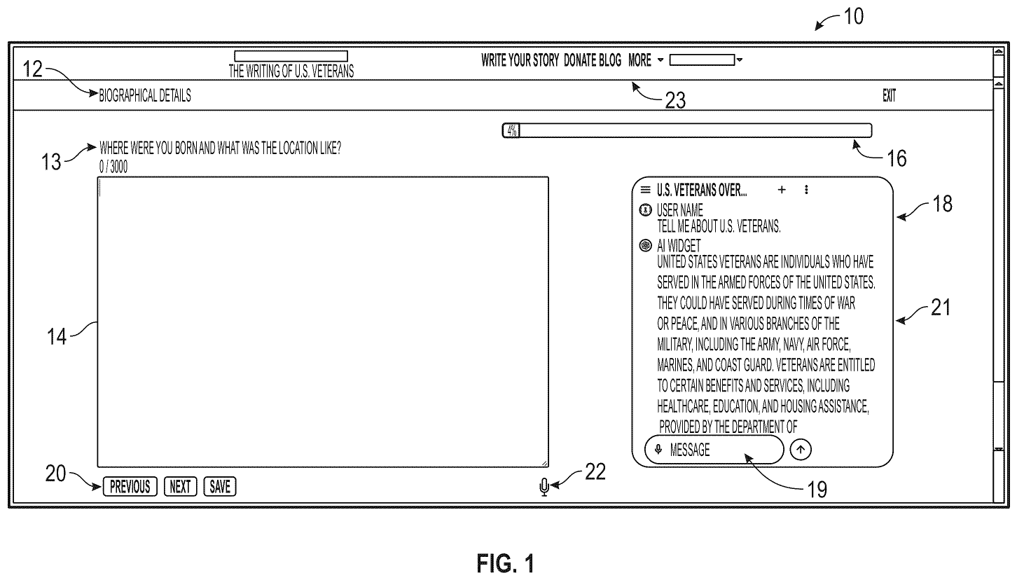

FIG. 1 shows a view of aspects of a writing platform system 10. As shown in FIG. 1, the system 10 can include a category indication 12, a question 13, a text area 14, a timeline 16, an AI chat widget 18, navigation options 20, a voice input button 22, and a ribbon 23.

The system 10 can be configured such that one or more questions 13 are provided and/or prompted to the user. Such question(s) 13 can be displayed via text to the user and/or provided in any other suitable manner such as via voice and/or audio output. FIG. 1 shows an example view of one question 13 prompted to a user. According to some embodiments, the question(s) 13 can comprise the Library Of Congress' Veterans History Project writing prompt questions. According to some embodiments, the question(s) 13 can comprise fifty questions.

The question(s) 13 can be divided into categories 12 wherein such categories 12 can include, but are not limited to, biographical details, early days of service, wartime service, end of service, reflections, and conclusion(s). According to some embodiments, the categories 12 can comprise the Library Of Congress' Veterans History Project writing prompt modules/categories. As shown in FIG. 1, the system 10 can prompt the user with a question 13 and can also display the category 12 to which the question 13 is a member. For example, in FIG. 1, the question 13 states “Where were you born and what was the location like?”. The category 12 associated with the question 13, as shown in FIG. 1, is “Biographical Details”. While, according to some embodiments, only one question is displayed at a time as is shown in the example of FIG. 1, more than one question can be displayed at a time. Further, as is shown in FIG. 1, the system 10 can include a text area 14 wherein a user can enter an answer and/or respond to the prompted question 13. While only one text area 14 is shown in FIG. 1, more than one text area 14 could be included. A user can write or copy and paste text into the text area(s) 14. According to some embodiments, the system 10 can limit text entered into the text area(s) 14 to 2000 words. According to some embodiments, the system 10 can limit text entered into the text area(s) 14 to 3000 words. According to some embodiments, the system 10 can limit text entered into the text area(s) 14 to 5000 words. According to some embodiments, the system 10 imposes no limit on the number of words and/or characters that can be entered into the text area(s) 14. The system 10 can further include a timeline 16 wherein said timeline 16 gives an indication of progress, i.e., how far along the user is in the system's 10 writing experience. By providing an indication of progress, the timeline 16 enables the user to start and stop writing as they like and to understand how far along they are in the process and how much of the process remains. As shown in FIG. 1, the timeline 16 can provide information related to the percent of the system's 10 writing experience that is complete. For example, in FIG. 1, the timeline 16 shows that the system's 10 writing experience is 4% complete. As the user progresses through the series of questions, the percent complete will increase. According to some embodiments, the timeline 16 can include a textual display of the percent of the writing platform system 10 that a user has completed and/or can provide a graphical display, such as a progress bar, of the percent of the writing platform system 10 that a user has completed.

As shown in FIG. 1, the system 10 can include an AI chat widget 18. According to some embodiments, the AI chat widget 18 can include a text input portion 19 and a text output portion 21. The AI chat widget 18 can provide information that may be utilized by the user such as by being copied and pasted. For example, such information can be important background and/or contextual material related to a user's response/answer to a question 13 presented by the system 10. The AI widget 18 allows the user to ask questions, copy content, and/or receive emotional support and/or advice in real time. A user can ask the AI chat widget 18 a question, wherein the AI chat widget 18 can provide an answer. According to some embodiments, the user can prompt and/or communicate with the AI widget 18 by typing into the text input portion 19 of the AI widget 18. According to some embodiments, the AI widget 18 can provide an answer and/or information to the user and/or communicate with the user via the output portion 21 of the AI widget 18. The user can then use the information provided by the AI widget 18 in the user's response/answer to a question 13 presented by the system 10. The AI chat widget 18 can provide context and/or background information to assist a user when writing his or her response/answer to the currently displayed question 13. As an example, a user could ask the AI widget 18 “who was the United States Secretary of Defense in the year 2005?” by typing this question into the text input portion 19 of the AI widget 18 and/or via voice input. The AI widget 18 could then answer this question with the correct information by outputting text via the text output portion 21 of the AI widget 18 and/or via voice and/or audio output. The user could then utilize the information provided by the AI widget 18 in the user's answer to a particular question 13. For example, the user could type and/or copy and paste the information provided by the AI widget 18 into the text area 14. Thus, the AI widget 18 allows a user to conduct research in an essentially instantaneous and/or real-time manner via the system 10 rather than separate from the system 10. Therefore, the AI widget 18 reduces and/or eliminates the need for a user to perform research separate from the system 10 that could be cumbersome, expensive, and/or time-consuming. Additionally, the AI widget 18 can help to improve the quality of the response to each question presented by the system 10 by providing helpful information. Consequently, any written product stemming from the system 10 such as a memoir or blog post will also enjoy improved quality. The AI widget 18 allows for the quality of written material stemming from the system 10 to be particularly increased for users that are not experienced writers and/or that are not tech-savvy. As noted, output of the AI widget 18 can be copied and pasted into the text area 14.

The AI chat widget 18 can incorporate ChatGPT and/or any other suitable AI technology known in the art. As noted, according to some embodiments, the AI chat widget 18 can include the text input portion 19 wherein a user can interact with the AI chat widget 18. Additionally or alternatively, according to some embodiments, the user can interact with the Al chat widget 18 via voice and/or audio input. As noted, the AI chat widget 18 can further include the text output portion 21 wherein the AI widget 18 can respond and/or provide information based on input from the user. Additionally or alternatively, according to some embodiments, the AI widget 18 can output information to the user via voice and/or audio output.

The AI chat widget 18 can provide real-time emotional support and/or advice in a variety of ways. For example, if, at any time while using the system 10, a user indicates that the user wants to commit suicide, the AI widget 18 is configured to prompt the user to contact the Veterans Crisis Line. For example, according to some embodiments, the AI widget 18 can provide the following message to the user via the text output portion 21 of the AI widget 18 and/or via voice and/or audio output: “Please contact the Veterans Crisis Line: Dial 988 then press 1 if you would like to speak with someone.” As noted, the AI widget 18 is configured to provide such emotional support and/or advice to the user upon any indication of the user wanting to commit suicide. Such an indication could come in the form of typing a statement that the user wants to commit suicide into the text area 14 and/or into the text input portion 19 of the AI widget 18. Additionally or alternatively, according to some embodiments, such an indication could come in the form of voice and/or audio input wherein a user verbally makes a statement that the user is thinking about and/or has contemplated suicide. According to some embodiments, an example statement by the user that would amount to such an indication of the user wanting to commit suicide can be: “I want to commit suicide”. According to some embodiments, the prompt related to contacting the Veterans Crisis Line in response to an indication that the user wants to commit suicide is only provided once per session of answering a question 13. According to some embodiments, the system 10 and/or AI chat widget 18 can be configured to prompt users with emotional support, guidance, and/or advice based on input other than an indication that the user wants to commit suicide. For example, the system 10 and/or AI widget 18 can be configured to prompt a user with emotional support and/or advice if the user indicates that the user is intoxicated and/or has been consuming alcohol or using drugs or any other substance, has PTSD and/or is experiencing PTSD symptoms, and/or is angry. Such emotional support, guidance, and/or advice can comprise a message to the user, provided via the output portion 21 of the AI widget 18 and/or via voice and/or audio output, that encourages the user to contact the Veterans Crisis Line to seek help. Such a message of emotional support could be the same as and/or similar to that provided in response to an indication of suicide. Again, an indication of alcohol usage, drug usage, usage of any other substance, PTSD, and/or anger could occur via any suitable format including, but not limited to, typing into the text area 14 and/or into the text input portion 19 of the AI widget 18 and/or via voice input. Providing such emotional support, guidance, and/or advice to users who are experiencing challenges related to suicide, alcohol usage, drug usage, usage of other substance(s), PTSD, and/or anger is an example of the system 10 providing a therapeutic benefit to users.

According to some embodiments, the AI chat widget 18 can be customizable based on user preferences. According to some embodiments, the output of the AI chat widget 18 can be customizable in order to output particular text. According to some embodiments, the AI chat widget 18 is customized to comply with the content style guide of the United States Department of Veterans Affairs (“VA”), which can be found at https://design.va.gov/content-style-guide/. Examples of the AI widget's compliance with the VA's content style guide include automatically outputting “U.S.” rather than “US”, automatically capitalizing the word “Veteran”, and/or only capitalizing military titles (e.g., “captain”, “major”, “colonel”, “general”, and the like) when these titles are used as part of a name and/or in place of a name. While these are only examples, the output of the AI chat widget 18 can be customized to include any suitable output. Such custom output can be applied for all responses of the AI chat widget 18. Additionally or alternatively, according to some embodiments, such customization, including but not limited to customized compliance with the VA's content style guide, can also be applied to the story/blog generation described herein such as via the story generation feature 48 and/or the story generation feature 148, which can be AI-assisted. Thus, when a story/blog post is generated via Al assistance, the generated story/blog post can include any customized output and/or wording, such as output and/or wording in compliance with the VA's content style guide.

Further, as is shown in FIG. 1, the system 10 can include navigation buttons 20 that allow a user to navigate through the series of question(s) 13 presented by the system 10 as well as save progress. For example, the navigation buttons 20 can include a “Previous” button to navigate to a previous question, a “Next” button to navigate to the next question, and a “Save” button to save a user's progress while responding to the questions 13. While buttons are shown in FIG. 1, any other type of input (voice input, keyboard input, etc.) could be included to allow a user to navigate between questions and/or to save progress.

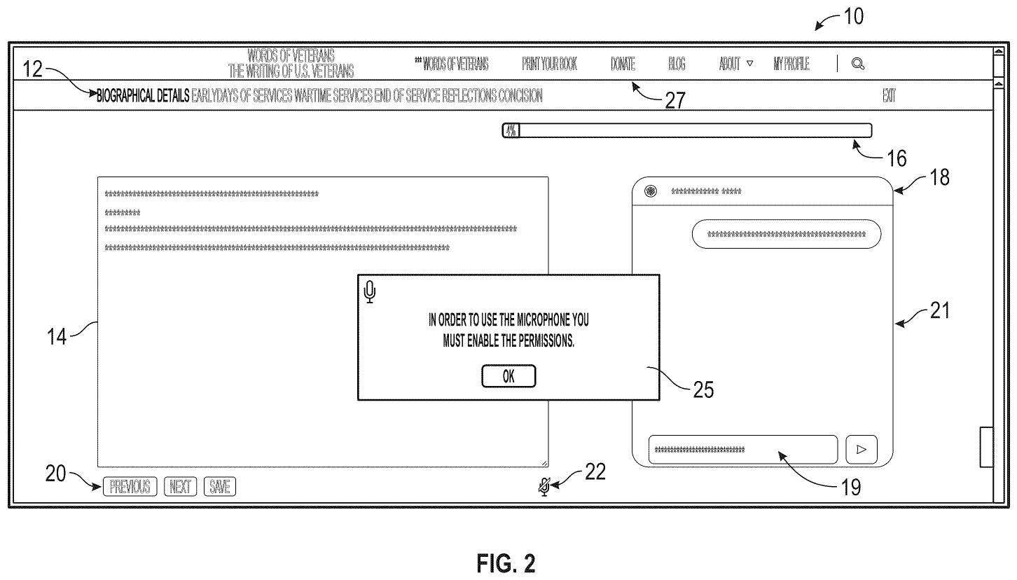

The system 10 can further include a voice input button 22. The voice input button 22 allows a user to provide voice and/or audio input to any aspect of the system 10. For example, voice and/or audio input could be used to respond to questions(s) 13, to interact with the AI chat widget 18, to navigate through the system 10, and/or any other aspects of the system 10. According to some embodiments, a user can provide voice and/or input via any auditory input mechanism of the computing device upon which the user is accessing the system 10. For example, if the user is accessing the system 10 via a computer and/or a smartphone, the user can provide voice input via an auditory input mechanism of the computer and/or smartphone, such as a microphone. Additionally or alternatively, a user could couple an auditory input mechanism external to the computing device upon which the user is accessing the system 10 with said computing device. The auditory input mechanism, whether part of the computing device and/or external thereto, could be any sort of mechanism capable of receiving voice and/or sound such as a microphone. As shown in FIG. 2, according to some embodiments, the system 10 can include a microphone permission pop-up window 25 wherein a user can grant permission for the computing device to use its auditory input mechanism, such as a microphone, with aspect(s) of the system 10. The system 10 can include the ability to perform voice-to-text conversion of the voice input from a user such that such voice input can be converted to text to be used for aspect(s) of the system 10. As noted, such aspect(s) of the system 10 that use voice-to-text conversion can include, but are not limited to, responding to question(s) 13, interacting with the AI chat widget 18, navigating through the system 10, and/or any other suitable aspect(s) of the system 10. According to some embodiments wherein a user is accessing the system 10 via a mobile device, the voice and/or audio input capability works best when using the Google Chrome browser to access the system 10.

As shown in FIG. 1, the system 10 can further include ribbon navigation 23 wherein a user can use the ribbon navigation 23 to navigate to other aspects of the system 10. The ribbon navigation 23 can be used to navigate to aspects of the system 10 described herein. The ribbon 23 can include selectable options including, but not limited to, tabs, buttons, and/or drop-down menus. As shown in at least FIG. 1, according to some embodiments, the ribbon 23 can include selectable options including, but not limited to, “Write Your Story”, “Donate”, “Blog”, and “More”. These selectable options can be used to navigate to other aspect(s) of the system 10. FIG. 1 shows a portion of the ribbon 23 that is blurred and/or obstructed. When a user is signed into the system 10, this blurred and/or portion, appearing next to the word “More” on the ribbon 23 can display the user's email address and/or username. This email address and/or username can become a drop-down menu when selected by a user wherein the system 10 can display additional options for a user to select. The ribbon 23 can further include a selectable option (such as a tab and/or button) for a user to sign-out/logout of the user's account. The system 10 can further include a selectable option for a user to exit the system 10. This selectable exit option is shown as the word “Exit” appearing in a top-right portion of FIG. 1.

According to some embodiments, a ribbon 27 having different selectable options than the ribbon 23 can be included as part of the system 10. For example, as shown in FIG. 2, the ribbon 27 can include selectable options including, but not limited to, “Print Your Book”, “Donate”, “Blog”, “About”, “My Profile”, and a magnifying glass that allows a user to search throughout the system 10. The ribbon 27 can operate in the same and/or similar manner as the ribbon 23 and/or any other ribbon described herein. For example, the ribbon 27 can be used to navigate to aspects of the system 10. As shown in FIG. 2, at least some embodiments that include the ribbon 27 can also include the selectable option for a user to exit the system 10.

According to some embodiments, the system 10 can provide the ability for a user to donate money and/or other resources such as book(s) to the system 10. According to some embodiments, the user can access the ability to donate by selecting the “Donate” option via the ribbon of the system 10. The “Donate” option can be selectable via the ribbon 23, the ribbon 27, and/or the ribbon 123. According to some embodiments, the system 10 can be configured to provide options for the users in terms of donations. For example, the system 10 can provide the option for a user to make a one-time donation and/or a recurring donation. According to some embodiments, a recurring donation can occur on a weekly basis, a monthly basis, and/or any other suitable time interval. The system 10 can be configured to provide the option for a user to cancel a recurring donation at any time. The system 10 can be configured to provide a text field and/or any other suitable input means wherein a user can submit a comment to the system 10. According to various embodiments, the text field can allow a user to type in the text field and/or can allow a user to provide speech and/or auditory input to the text field.

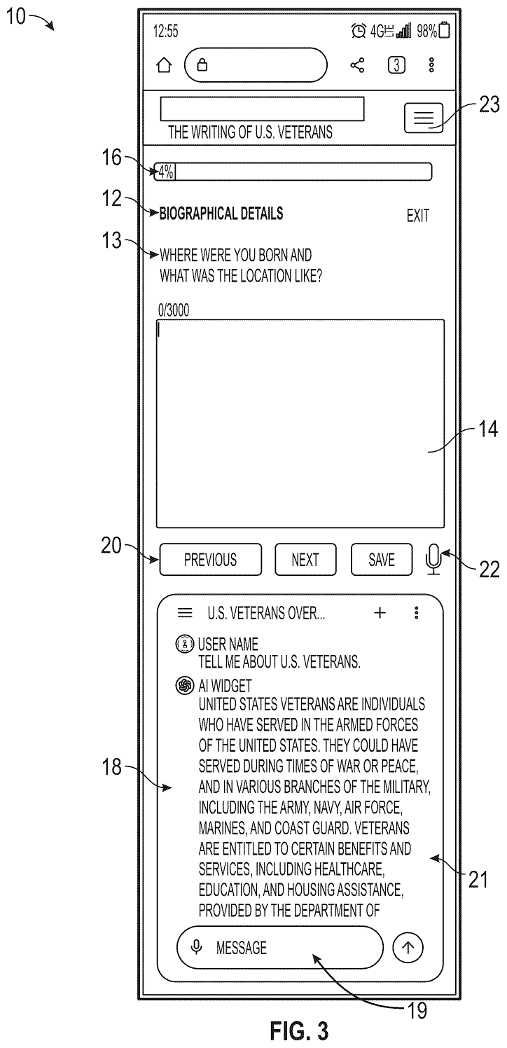

FIG. 3 shows a view of the same aspects of the writing platform system 10 that are included in FIG. 1. FIG. 3 shows the aspects of FIG. 1 in a mobile format rather than in a personal computer format. All aspects of FIG. 1 can be included in FIG. 3 and can function in the same and/or similar manner as described with reference to FIG. 1. As mentioned, the system 10 can be implemented and can be accessible in a personal computing environment/format (capable of access via desktop computer, laptop computer, etc.) and/or in a mobile environment/format (capable of access via a smart phone, tablet, etc.).

While not shown in any of FIGS. 1-3, the system 10 can include input means, such as a selectable button, that can appear below the AI widget 18 and/or any other suitable location that, when selected, either generates a story based on the consolidated question(s) and response(s) 24 and/or creates a book based on the consolidated question(s) and response(s) 24 and/or a generated story. Such story generation can be performed as described herein with reference to the story generation feature 48 and/or the story generation feature 148. Such book creation can be performed as described herein with reference to the book creation feature 200. According to some embodiments, this input means (such as a selectable button) can be configured to generate a story and can be invisible and/or disabled until a user provides a response to each of the question(s) 13 and the total word count of the user's response(s) to the question(s) 13 is greater than 1000 words. Thus, when a user provides a response to each of the question(s) 13 and the total word count of the response(s) is greater than 1000 words, the input means (such as a selectable button) configured to generate a story based on the consolidated question(s) and response(s) 24 can automatically be made visible and/or be enabled. According to some embodiments, if the user has already generated a story, the input means (such as a selectable button) can be configured such that selecting the input means creates a book based on the consolidated question(s) and response(s) 24 and/or the generated story. When the input means is configured to generate a story, the input means can include text reading “Share Your Story”, “Create Your Blog Post”, and/or something similar. When the input means is configured to create a book, the input means can include text reading “Create Your Book”, “Print Your Book”, or something similar.

According to some embodiments, the system 10 can include a Home page wherein a user can navigate to the Home page. The Home page can include input means, such as a selectable button, that includes text reading “Start Writing For Free” or something similar. The system 10 can be configured such that when a user selects the input means, the system can navigate the user to a view, page, and/or portion of the system 10 wherein the system 10 displays the question(s) 13 and the AI widget 18, and the user can provide a response to each of the question(s) 13. According to some embodiments, such a view, page, and/or portion could be and/or be similar to that shown in FIG. 1 or FIG. 3 According to some embodiments, such input means could be located on any view and/or portion of the system 10.

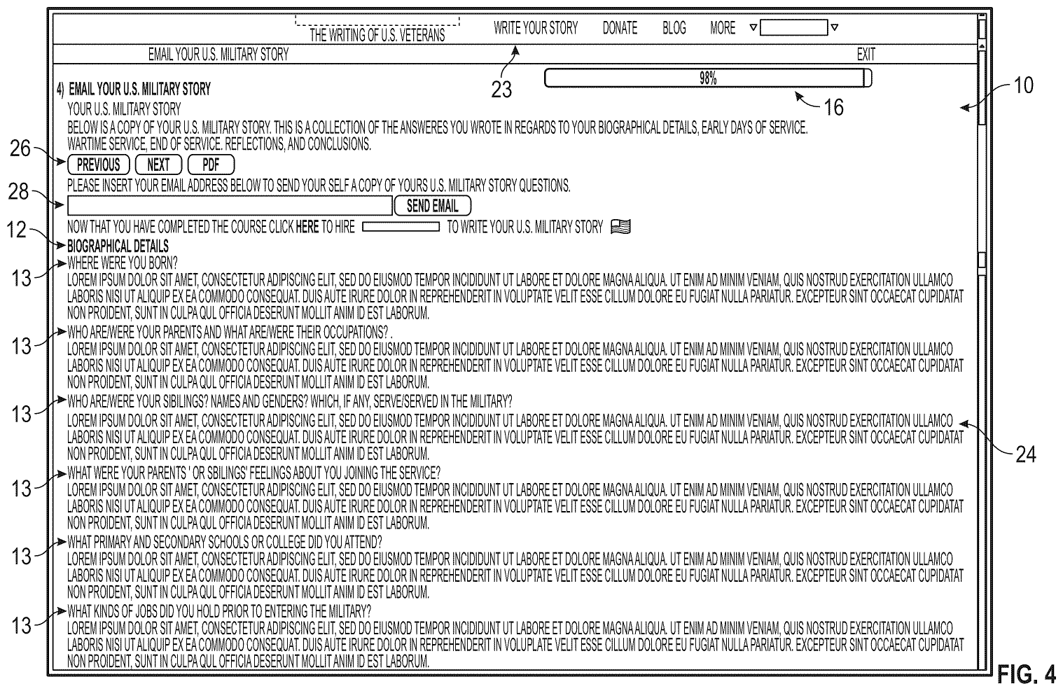

FIG. 4 shows a view of a portion of consolidated question(s) and response(s)/answer(s) 24 to said question(s) 13 as provided by the system 10. The system 10 is configured to compile and/or consolidate each question 13 presented to a user and the user's response to each question 13. The system 10 is then configured to display such consolidated question(s) and response(s) 24. According to some embodiments, the consolidated question(s) and response(s) 24 can be displayed in a single view. FIG. 4 shows only a portion of the consolidated question(s) and response(s) 24. The number of question(s) 13 can include more than those shown in FIG. 4. The consolidated question(s) and response(s) 24 can be displayed to the user. The consolidated question(s) and answer(s) 24 can include additional navigation buttons 26 which can include a “Previous” button to navigate to a previous aspect of the system 10, a “Next” button to navigate to the next view of the system 10, and/or a “PDF” button to save and/or print the consolidated question(s) and response(s) 24 in a PDF format. Additionally, the consolidated question(s) and response(s) 24 can be saved and/or printed in any other suitable format such as via Microsoft Word and the like. While buttons are shown in FIG. 4 for a user to access the additional navigation buttons 26, any other type of input (voice input, keyboard input, etc.) could be included to allow a user to navigate between aspects of the system 10 and/or to save/print the consolidated question(s) and/or response(s) 24.

The consolidated question(s) and response(s) 24 can further include an email option 28. The email option 28 can include a text field wherein a user can enter an email address. Additionally, the system 10 can provide an input option (a “Send Email” button in FIG. 4) wherein a user can select the input option/button to send a copy of the consolidated question(s) and response(s) 24 to an email address specified by the user by entering said email address into the text field.

According to some embodiments, when the consolidated question(s) and response(s) 24 are saved, printed, and/or emailed, the system 10 is further configured to generate a certificate. According to some embodiments, the saved, printed, and/or emailed consolidated question(s) and response(s) 24 can comprise and/or can be formatted as a certificate that includes, without limitation, a border, a seal, a title, and the name of the user.

Again, according to some embodiments, only a portion of the total question(s) 13 that can be prompted by the system 10 to a user can be seen in FIG. 4. The response(s) shown in FIG. 4 to the question(s) 13 are simply example placeholders. While many question(s) can be prompted to the user, according to some embodiments, only a portion of the question(s) 13 described herein are prompted by the system 10 to the user. According to some embodiments, the system 10 prompts the user with additional question(s) not described herein.

According to some embodiments, the question(s) 13 prompted by the system 10 to the user can include, but are not limited to, question(s) 13 in six different categories 12 wherein the categories 12 can include, but are not limited to, Biographical Details, Early Days of Service, Wartime Service, End of Service, Reflections, and Conclusion.

The question(s) 13 in the Biographical Details category 12 can include, but are not limited to, “Where were you born and what was it like?”; “Who are/were your parents and what are/were their occupations?”; “Who are/were your siblings? Names and genders? Which, if any, serve/served in the military?”; “What were your parents' or siblings' feelings about you joining the service?”; “What primary and secondary schools or college did you attend?”; and “What kinds of jobs did you hold prior to entering the military?”.

The question(s) 13 in the Early Days of Service category 12 can include, but are not limited to, “Can you tell us about when you went into the military? Were you drafted, or did you volunteer?”; “(If volunteered) Why did you join?”; “What or who did you leave behind (family, child, pet) when you left to serve?”; “In which branch did you enter?”; “(If volunteered) Why did you choose that branch?”; “How did you get to your initial point of entry?”; “What type of training or schooling did you have? (Advance Course Warrant Officer Basic, Warrant Officer Advance, Warrant Officer Senior Course, ‘Boot-strap’ Command and General Staff College or equivalent, War College or equivalent (getting a degree either Bachelors, Masters or PhD)”; “What is your most vivid memory of your time training or in school? What was the best part? What was the worst part?”; “Does any particular instructor stand out in your mind? If yes, why?”; “What was your first assignment after basic training?”; “Did you receive any specialized training? If so, what?”; “Do you recall your instructors? If so, what were they like?”; “Did you qualify with equipment (vehicles, aircraft, radios, weapons, etc.)? (If Yes) What was training with that equipment like?”; “What was the hardest part of training?”; “Did you receive any promotions? Could you tell me about them?”; “What was the hardest part of the military life-style for you to adapt to? Why do you think it was?”; “What was the easiest part of the military life-style for you to adapt to? Why do you think it was?”.

The question(s) 13 in the Wartime Service category 12 can include, but are not limited to, “Where did you serve?”; “What are your recollections of that experience?”; “Were you in a combat, combat support, or combat service support role? Or did the war zone make that designation irrelevant?”; “(If combat/wartime) How did your combat (wartime) experience change you?”; “What kinds of friendships and camaraderie did you form while serving, and with whom?”; “How did you stay in touch with family and friends?”; “What did you do for recreation or when you were off duty?”; “Do you recall any particularly humorous or unusual events?”; “Was there something you did for ‘good luck?’”; “What was the best part of your service experience?”.

The question(s) 13 in the End of Service category 12 can include, but are not limited to, “Do you recall the day service ended? Where were you when your service ended?”; “Did you return home? Where were you?”; “How were you received by your family and community?”; “How did you readjust to civilian life? Did you work or go back to school?”; “Did the G.I. Bill support your education?”; “How did service change you?”; “Did you continue any friendships after service? For how long?”; “How did service affect the way you relate to others?”; “Did you join a Veteran organization?”; “Do you attend reunions?”.

The question(s) 13 in the Reflections category 12 can include, but are not limited to, “How did your military service experiences affect your life?”; “What are some life lessons you learned from your military service?”; “How has your military service impacted your feelings about war and the military in general?”; “What message would you like to leave for future generations who will view/hear this interview?”; “Do you have a U.S. military quote you would like to share?”.

The question(s) 13 in the Conclusion category 12 can include, but are not limited to, “Is there anything you would like to add that we have not covered?”; “Is there anything you've always wanted to share about your service or veteran experience that you never have?”; “What would you like people to know or remember from your story?”; “Is there anything else we should talk about that we haven't covered?”; “What do you wish more people knew about Veterans?”

According to some embodiments, the system 10 can be configured to offer a voucher related to completion of each of the question(s) 13 presented by the system 10. For example, if a user answers all of the question(s) 13, the user can receive a voucher for free AI output. This voucher functionality can incentivize users to finish answering all of the question(s) 13.

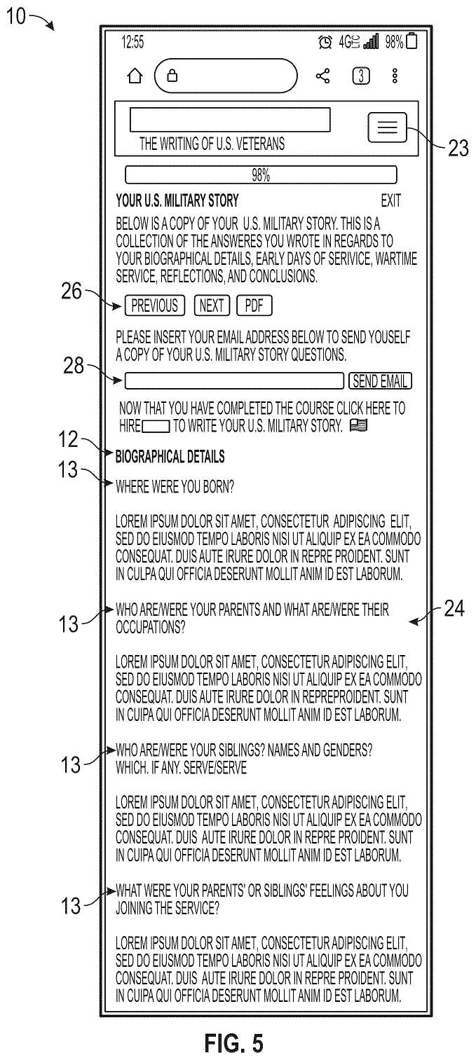

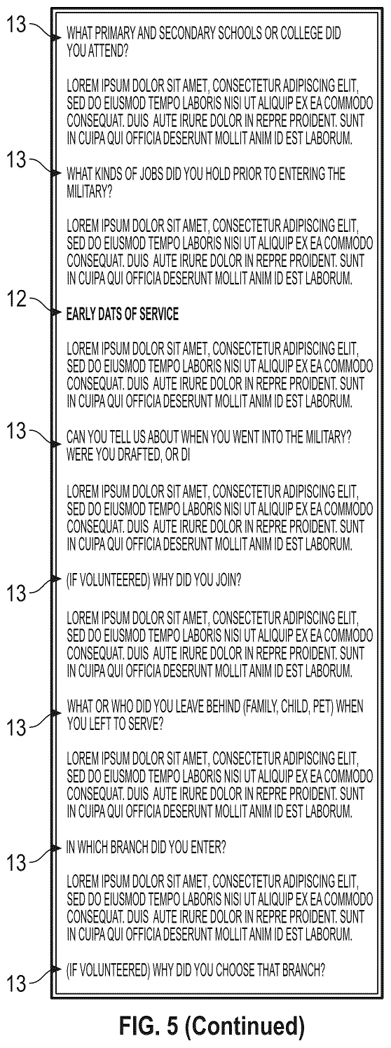

FIG. 5 shows a view of some aspects of the writing platform system 10 that are included in FIG. 4. FIG. 5 shows some aspects of FIG. 4 in a mobile format rather than in a personal computer format. All aspects of FIG. 4 can be included in FIG. 5 and can function in the same manner and/or similar manner as described with reference to FIG. 4. Again, the system 10 is capable of displaying the consolidated question(s) and response(s) 24 in a single view, but only a portion of the consolidated question(s) and response(s) 24 are shown in FIG. 5 for convenience/ease of viewing. While some of the question(s) 13 of the consolidated question(s) and response(s) 24 may be shown to be cut-off/truncated in FIG. 5, the system 10 is fully capable of being implemented in a mobile format wherein all aspects of the consolidated question(s) and response(s) 24 are fully displayed such that a user can view each complete question 13 and each complete response to said question(s) 13. As shown in FIG. 5, more of the consolidated question(s) and response(s) 24 are shown in FIG. 5 than in FIG. 4.

While not shown in either of FIG. 4 or 5, the system 10 can include input means, such as a selectable button, that can appear below the consolidated question(s) and response(s) 24 and/or any other suitable location that, when selected, either generates a story based on the consolidated question(s) and response(s) 24 and/or creates a book based on the consolidated question(s) and response(s) 24 and/or a generated story. Such story generation can be performed as described herein with reference to the story generation feature 48 and/or the story generation feature 148. Such book creation can be performed as described herein with reference to the book creation feature 200. According to some embodiments, this input means (such as a selectable button) can be configured to generate a story and can be invisible and/or disabled until a user provides a response to each of the question(s) 13 and the total word count of the user's response(s) to the question(s) 13 is greater than 1000 words. Thus, when a user provides a response to each of the question(s) 13 and the total word count of the response(s) is greater than 1000 words, the input means (such as a selectable button) configured to generate a story based on the consolidated question(s) and response(s) 24 can automatically be made visible and/or be enabled. According to some embodiments, if the user has already generated a story, the input means (such as a selectable button) can be configured such that selecting the input means creates a book based on the consolidated question(s) and response(s) 24 and/or the generated story. When the input means is configured to generate a story, the input means can include text reading “Share Your Story”, “Create Your Blog Post”, and/or something similar. When the input means is configured to create a book, the input means can include text reading “Create Your Book”, “Print Your Book”, or something similar.

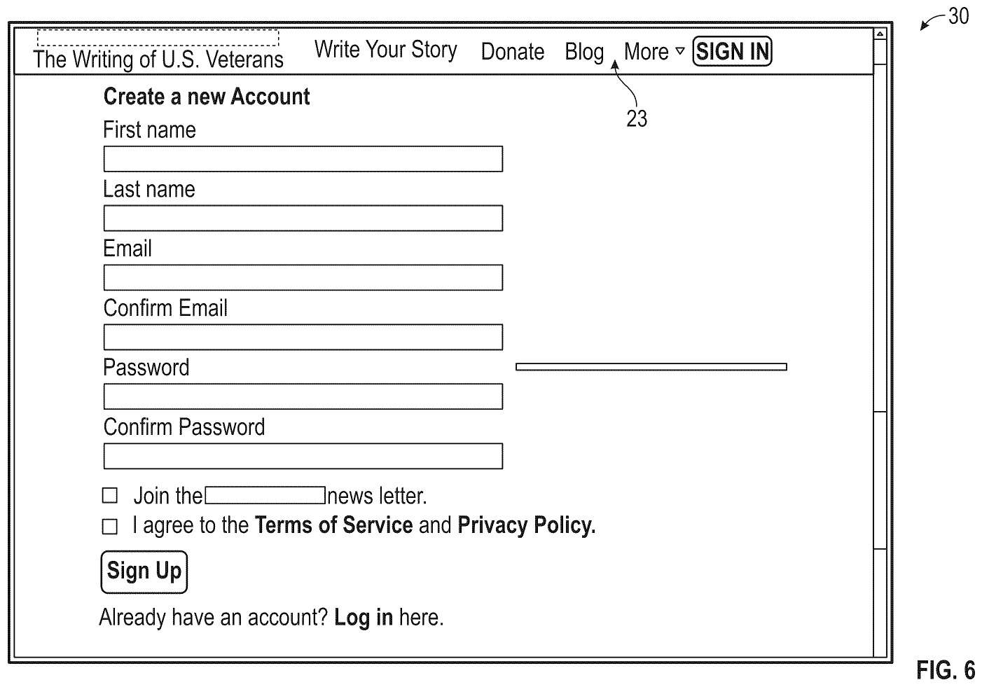

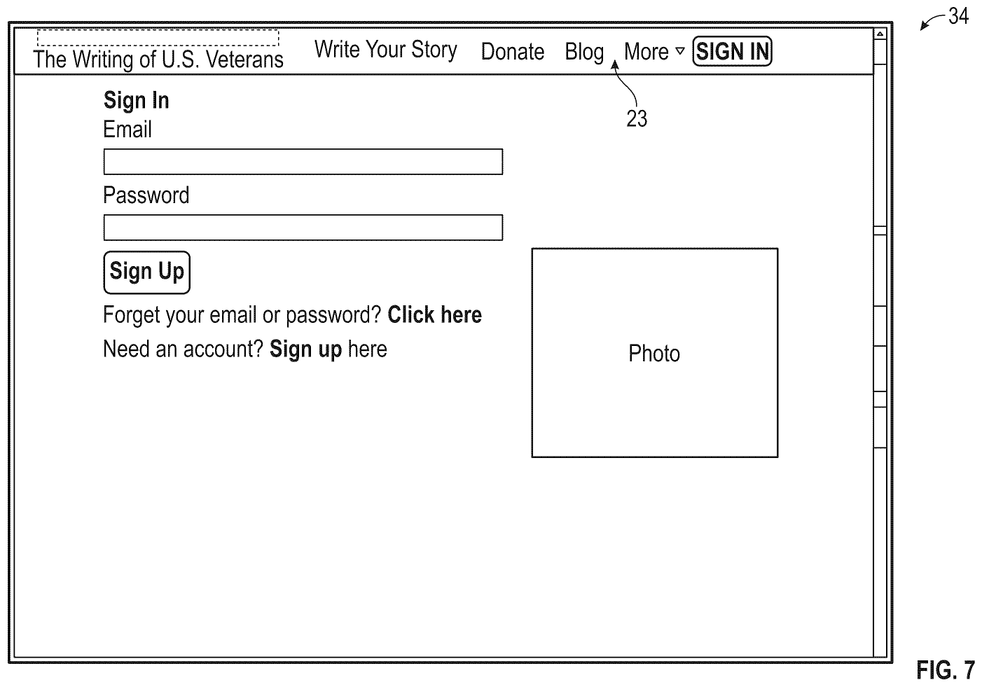

FIG. 6 shows a view of a create account feature 30 of the system 10 that allows a user to create an account. This create account feature 30 allows a user to enter information via text field and/or any other suitable manner in order to create an account to access the system 10. The create account feature 30 can include a text field for several datapoints. For example, FIG. 6 shows the create account feature 30 to include multiple text fields in which a user can enter a first name, a last name, an email address, an email address confirmation, a password, and a password confirmation. According to some embodiments, the create account feature 30 can include a text field to allow for a user to create and/or enter a pseudonym to identify the user in place of providing a first name, last name, and/or email address. The use of a pseudonym contributes to the privacy maintained by the system 10. Additionally, the use of a pseudonym allows for the user to maintain anonymity. Additionally or alternatively, according to some embodiments, the create account feature 30 provides the ability for a user to create an account using Google or Facebook. For example, a user can create an account using his or her Google or Facebook account. The create account feature 30 can further include input means (shown as a checkbox in FIG. 6) wherein a user can select whether or not to receive a newsletter. According to some embodiments, this newsletter can be sent by the system 10 to users via email. This newsletter can comprise one or more quotations wherein such quotations are related to military service, are quotations of famous individual(s), and/or are inspiring. Such quotations can be delivered via email on a recurring basis, such as on a weekly basis. According to some embodiments, these types of quotations can also be posted on social media controlled by the system 10. According to some embodiments, the system 10 is configured to post these types of quotation(s) as well as video(s) and/or other content via the social media controlled by the system 10. According to some embodiments, the system 10 is configured to provide the capability for a user to order and/or purchase an eBook that includes many of these types of quotations. The eBook can also include link(s) to the social media controlled by the system 10. According to some embodiments, the system 10 is configured to send a recurring email to users who have not responded to all the question(s) 13 reminding them to respond to the question(s) 13 and providing a hyperlink in the email to navigate to the system 10 in order to respond to the question(s) 13. Such a reminder email can be sent monthly and/or according to any suitable time interval. Once a user finishes responding to each of the question(s) 13, the system 10 is configured to stop sending such a reminder email to the user. According to some embodiments, the system 10 is configured to send a recurring email to users who have finished responding to each of the question(s) 13 but have not yet generated and published a story/blog post wherein the email encourages the user to use the system 10 to generate and publish a story/blog post as described herein. This type of email regarding story/blog post generation and publication can be sent monthly and/or according to any suitable time interval. Once a user generates and publishes a story/blog post, the system 10 is configured to stop sending this story/blog post generation and publication email to the user. According to some embodiments, the system 10 is configured to send a recurring email to users who have finished responding to each of the question(s) 13 but have not yet created a book wherein the email encourages the user to use the system 10 to create a book as described herein. This type of email regarding book creation can be sent monthly and/or according to any suitable time interval. Once a user creates a book, the system 10 is configured to stop sending this book creation email to the user. The create account feature 30 can further include input means (shown as a checkbox in FIG. 6) wherein a user can select the checkbox to indicate that the user agrees to the terms of service and/or privacy policy of the system 10. The create account feature 30 can further include a button, and/or other suitable input means, that a user can select in order to create an account once necessary information has been input. As shown in FIG. 6, this button can read “Sign Up” or can include any other text. The create account feature 30 can further include an option for a user to navigate to a login feature 34 if the user already has an account wherein said login feature is shown in FIG. 7. According to some embodiments, the create account feature 30 can be embodied via a pop-up message.

FIG. 7 shows a view of a login feature 34 of the system 10. The login feature 34 allows a user to sign-in/login to the system 10 so that a user can access aspects of the system 10. While some aspects of the system 10 can be accessed without creating an account and/or signing into the system 10, other aspects of the system 10 can only be accessed if a user creates an account and is signed into said account. The login feature 34 can include text fields in which a user can enter an email address and a password in order to login to the system 10. The login feature 34 can include a button, or other suitable input means, that the user can select in order to sign-in to the user's account to access aspect(s) of the system 10 once the user has entered the proper email address and password. This button can read “Sign In”, as shown in FIG. 7, or can include any other text. The login feature 34 also includes an option that allows a user to recover an account if a user forgets his or her email address and/or password. The login feature 34 can further include a navigation option to navigate to the create account feature 30. Additionally, while not shown in FIG. 7, the login feature 34 can include a selectable option wherein, when selected, the system 10 remembers the user's login credentials including at least the user's email address and password. Thus, by remembering the user's login credentials, the system 10 allows a user to quickly and easily login to the system 10 at a later date/time wherein the user does not need to manually enter the user's login credentials. According to some embodiments, the login feature 34 provides the ability for a user to login/sign-in to an account using Google or Facebook. For example, a user can login/sign-in to the user's account on the system 10 using his or her Google or Facebook account. According to some embodiments, the login feature 34 can be embodied via a pop-up message.

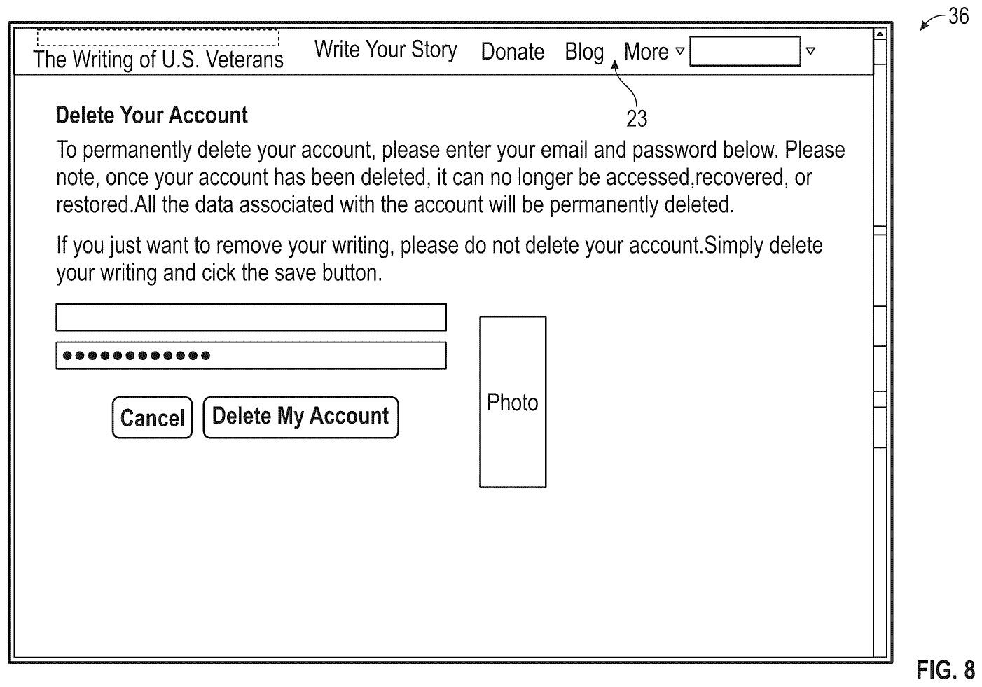

FIG. 8 shows a delete account feature 36 of the system 10. It is noted that the terms “profile” and “account” when referring to a user's profile/account can be used interchangeably herein. The delete account feature 36 allows a user to delete his or her account and all writing stored therein if the user chooses to do so, which increases comfort, privacy, and security. The delete account feature 36 can include text fields wherein a user can enter his or her email address and password and click a button to delete his or her account. This button can read “Delete My Account”, as shown in FIG. 8, or can include any other text. The delete account feature 36 can further include a “Cancel” button wherein the “Cancel” button can be selected by a user if said user does not want to delete his or her account. While buttons are shown in FIG. 8 to delete an account or cancel deletion, any suitable input means could be used in addition to and/or alternative to buttons. According to some embodiments, the delete account feature 36 can include a button to delete an account and/or a cancel button that can be selected if a user does not want to delete his or her account wherein the delete account feature 36 does not include any text field(s) for email address, password, and/or any other text field(s).

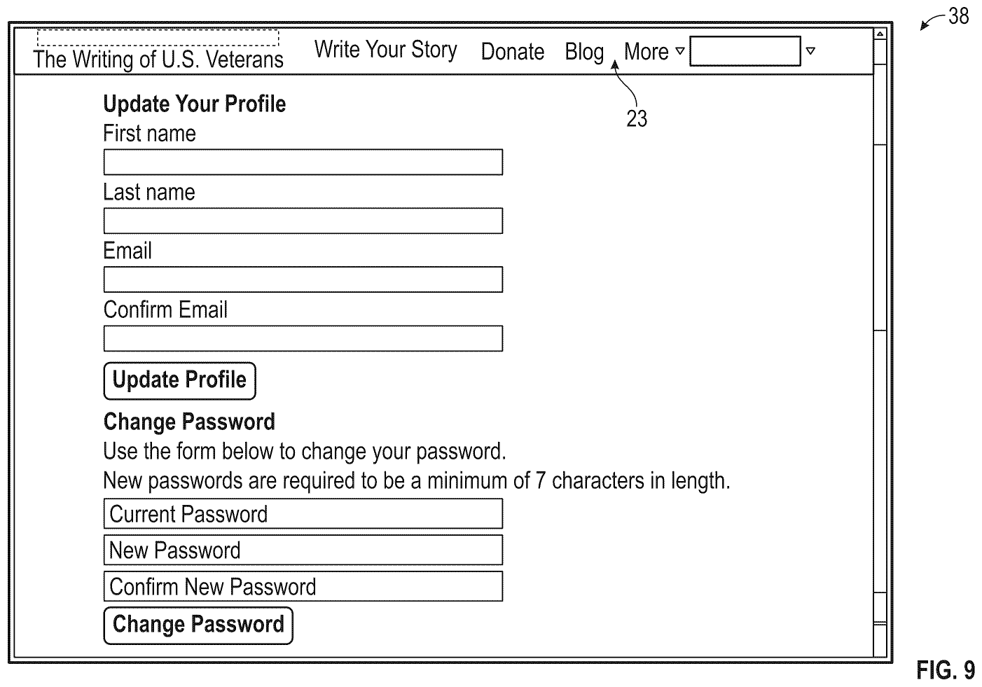

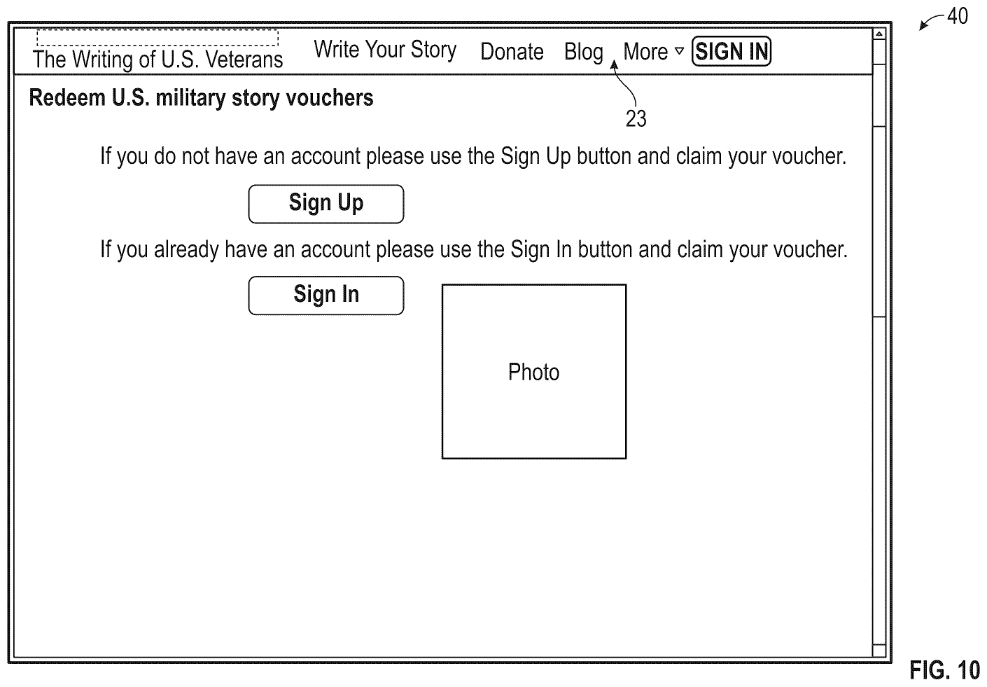

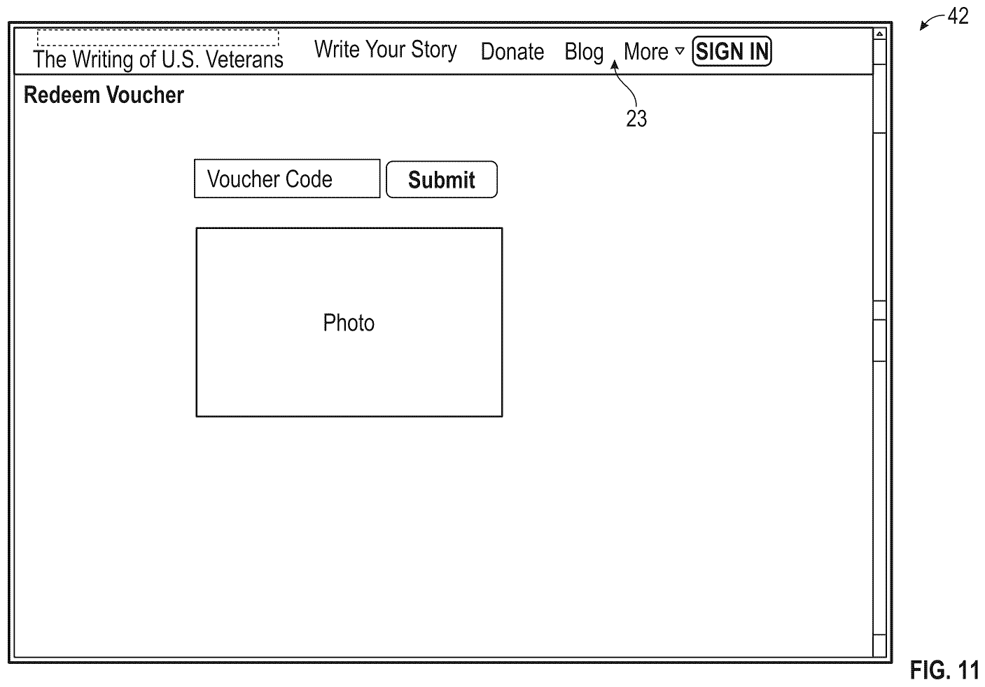

FIG. 9 shows an update profile/account feature 38 of the system 10. The update account feature 38 allows a user to update the first name, last name, and/or email address associated with the user's account. Additionally or alternatively, according to some embodiments, the update account feature 38 can allow a user to update the user's pseudonym, which can be used to identify the user in place of a first name, last name, and/or email address. Again, the use of a pseudonym contributes to the privacy maintained by the system 10. Additionally, a user can maintain anonymity by using a pseudonym. The update account feature 38 can include text fields wherein a user can input new information to update the user's account. The text fields can include, but are not limited to, pseudonym, first name, last name, email address, and/or confirmation of email address. The update account feature 38 can further include additional text fields that allow a user to change the password associated with the user's account. Such text fields can allow a user to enter a current password, a new password, and confirmation of the new password. The update account feature 38 can include button(s), wherein once necessary information is entered, the user can select one or more of the button(s) to update the user's profile/account and/or to change the user's password.

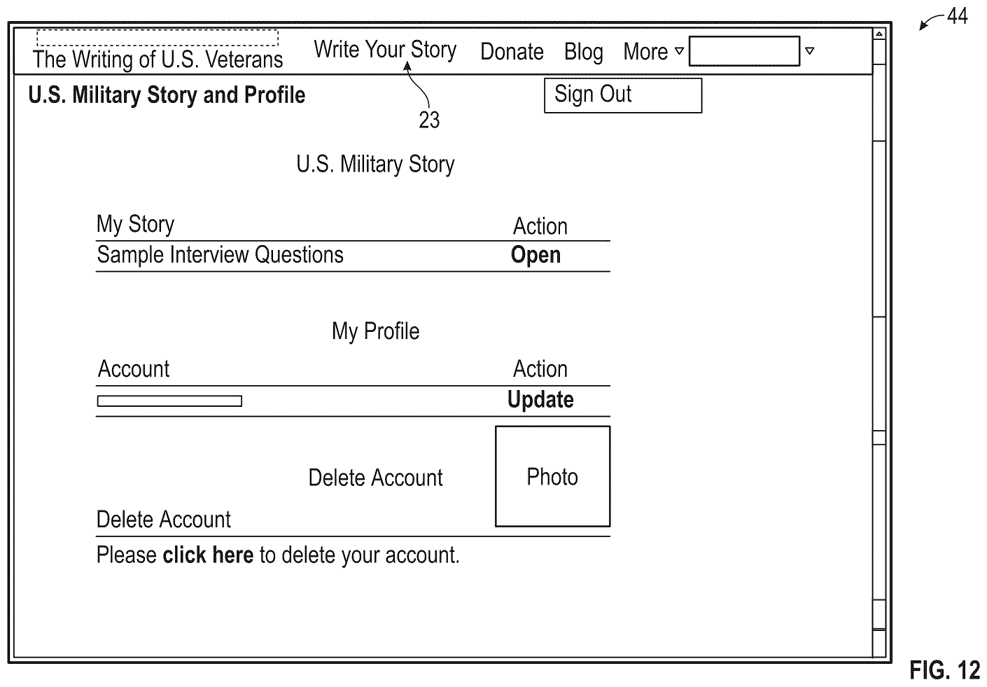

FIG. 10 shows a login/sign-up feature 40 of the system 10 wherein the login/sign-up feature 40 is associated with voucher redemption. The login/sign-up feature 40 associated with voucher redemption can allow and/or require a user to sign up for/create an account and/or sign in/login before redeeming a voucher. The login/sign-up feature 40 associated with voucher redemption can provide button(s), and/or other input means, to navigate to the create account feature 30 or to the login feature 34.

FIG. 11 shows a voucher redemption feature 42 of the system 10 wherein a user can enter a voucher code to redeem a voucher. The voucher redemption feature 42 can include a text field that allows a user to enter a voucher code. The system 10 provides a button that a user can select to redeem a voucher once the voucher code is entered. A redeemed voucher can allow a user to access some and/or all aspects of the system 10 at a discounted price and/or free of charge. While a button is shown in FIG. 11 to redeem a voucher, any suitable input means can be used.

According to some embodiments, the system 10 allows a user to purchase and/or acquire multiple vouchers wherein said user can distribute those vouchers to others. According to some embodiments, the user must be logged into an account in order to purchase and/or acquire voucher(s). A user could purchase a single voucher at a time and/or purchase multiple vouchers. According to some embodiments, a user could purchase two vouchers for the price of one, twenty vouchers at a 20% discount, and/or 100 vouchers at a 25% discount. These purchase and discount examples are not limiting. Rather, according to some embodiments, the system 10 could be configured to allow a user to purchase a varying amount of voucher(s) at various discount(s).

Once a user has purchased and/or acquired voucher(s), the system 10 is configured to allow the user to distribute/transfer said voucher(s) to others. The system 10 allows a user to input an email address wherein a user can send, distribute, and/or transfer one or more vouchers via email. When a user sends, distributes, and/or transfers one or more vouchers via email, the email can contain one or more voucher codes that each correspond to one of the one or more vouchers. The recipient of the email can then redeem the voucher(s) at the time of and/or after creating an account and/or redeem the voucher(s) by first logging into the system 10 if the recipient already has an account. The email containing the voucher(s) and their code(s) can also include a link to the system 10 wherein a user can navigate directly to the system 10 to redeem the voucher(s), create an account, and/or log into an account. Each voucher can cover some and/or all of the cost of creating an account and/or accessing the writing platform system 10. Thus, the system 10 allows for an entity to purchase multiple vouchers wherein the entity can then distribute the vouchers to recipients such that each recipient can create an account and/or access the system 10 for free and/or at a reduced price.

Also, according to some embodiments, after a user purchases and/or acquires one or more vouchers, said user can redeem one or more vouchers rather than distribute and/or transfer them wherein the user can create an account and/or access the system 10 for free and/or at a discount based on the one or more vouchers.

According to some embodiments, the system 10 is configured to provide confirmation to the user regarding voucher(s) that have been sent, distributed, and/or transferred. The system 10 can display voucher(s) that have been sent, distributed, and/or transferred by the user and can allow a user to select said voucher(s) to view them.

According to some embodiments, the system 10 is configured to provide confirmation to the user regarding voucher(s) that have been redeemed. The system 10 can display voucher(s) that have been redeemed by the user and/or can display voucher(s) that have been sent, distributed, and/or transferred by the user and redeemed by a recipient. The system 10 can allow a user to select said displayed voucher(s) to view them.

FIG. 12 shows an overview feature 44 of the system 10. As shown in FIG. 12, the overview feature 44 can provide a user with an overview of the user's account. The overview feature 44 can allow a user to continue providing response(s) to the question(s) 13, view the consolidated question(s) and response(s) 24, continue creating a book, view the current state of the book, update the user's account, and/or delete the user's account. For example, the overview feature 44 can include an option to navigate to the question(s) 13 to provide a response and/or to navigate to the consolidated question(s) and response(s) 24. The overview feature 44 can include an option to navigate to the update profile feature 38. The overview feature 44 can include an option to navigate to the book creation feature 200. The overview feature 44 can include an option to navigate to the delete account feature 36. The overview feature 44 can include a progress report regarding the user's response(s) to the question(s) 13 and/or regarding creation of a book. For example, the overview feature 44 can display an indication of whether a user has not yet finished responding to all of the question(s) 13 and/or whether the user has finished responding to all of the question(s) 13. As another example, the overview feature 44 can display an indication of whether a user has not yet completed creation of a book and/or whether creation of a book is complete. According to some embodiments, the overview feature 44 can display a user's voucher(s) and/or voucher code(s) and/or the overview feature 44 can include a selectable option for a user to navigate to another portion of the system 10 to view the user's voucher(s).

Additionally, as shown in a top-right portion of FIG. 12, the overview feature 44 can include a button, or other input means, for a user to sign-out/logout of the user's account. While a sign-out button is shown in conjunction with the overview feature 44 in FIG. 12, other feature(s) and/or aspect(s) of the system 10 can include a sign-out option that allows a user to sign-out/logout of his or her profile/account and/or sign-out/logout of the system 10.

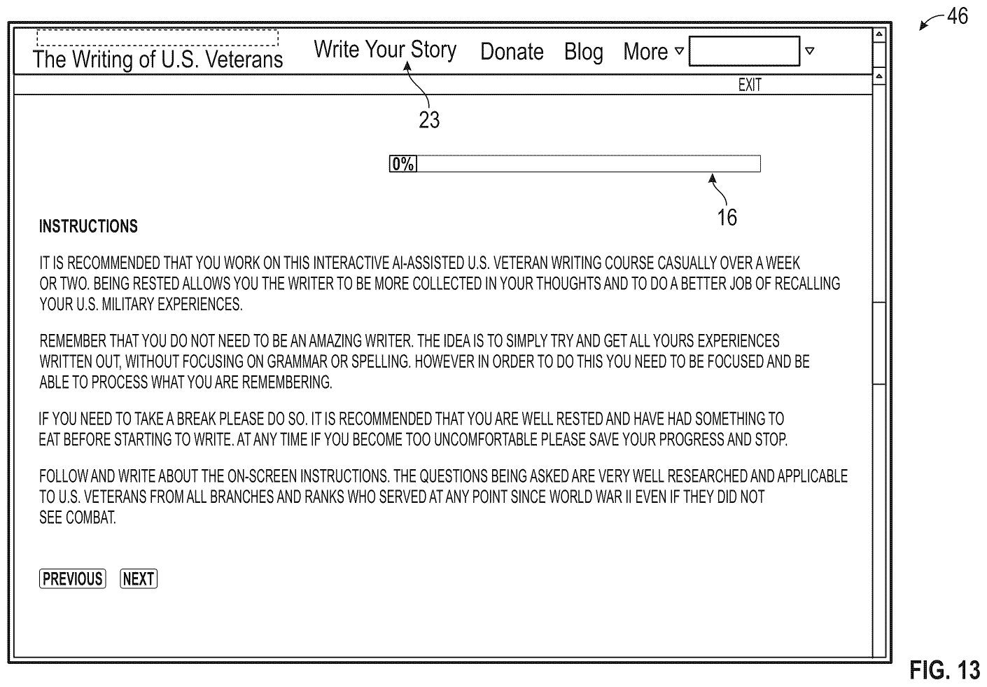

FIG. 13 shows an instructions feature 46 for the system 10. The instructions feature 46 can provide instructions to the user by displaying said instructions and/or by other means such as by voice output and/or visual output. The instructions can provide insight to the user regarding advice about how to use aspect(s) of the system 10. For example, according to some embodiments, the instructions feature 46 can include an instructional video regarding how best to use and/or access aspect(s) of the system 10 when using a mobile device such as a smartphone, regarding use of the AI widget 18, and/or regarding how to make a donation to the system 10. According to some embodiments, the instructions feature 46 can include displaying the text shown in FIG. 13. Additionally or alternatively, according to some embodiments, the instructions feature 46 can include displaying the following text: “If using the Words of Veterans website on a mobile phone, you will need to use the keyboard microphone. It is recommended to use the Google Chrome browser for the best results. The Safari and Edge browsers work, but the microphone is a bit unpredictable on different types of devices. No other browsers are recommended. There also is a ChatGPT widget that is a very useful tool for doing research and writing. It can do a lot of the work for you. After asking a question, simply copy and paste the results into the text area and press the save button. Please consider making a small donation to help support this Service-Connected Veteran-Owned Small Business.” While the instructions shown in FIG. 13 reference U.S. Veterans, again, the system can be applicable to all Veterans as well as others. As shown in FIG. 13, the instructions feature 46 can include navigation buttons to navigate to a previous aspect and/or to the next aspect of the system 10. According to some embodiments, the instructions feature 46 can include a selectable link that, when selected, provides the user the ability to make a donation to the system 10. According to some embodiments, the instructions feature 46 can include a disclaimer stating “All above services are to help the U.S. Veteran develop their story. I am not a licensed psychotherapist or counselor. I am simply a service-connected Veteran trying to help you tell your story.” According to various embodiments, this disclaimer can be included on any view, page, and/or portion of the system 10.

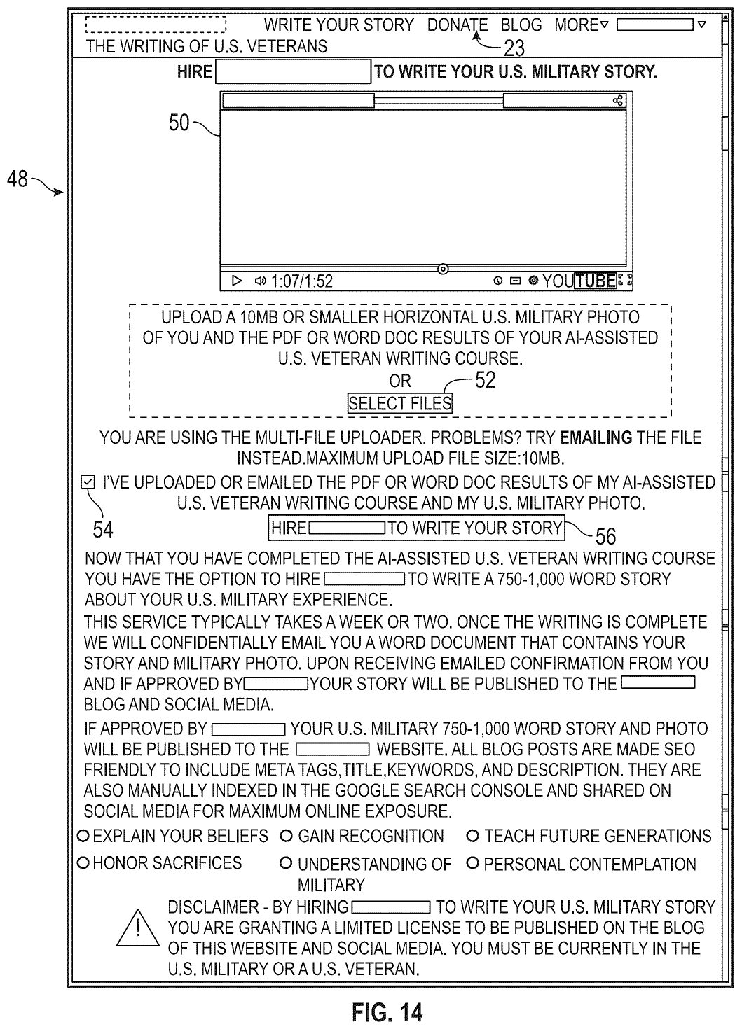

FIG. 14 shows a story generation feature 48 that can be included as part of the system 10. The story generation feature 48 allows a user to upload a copy of the user's consolidated question(s) and response(s) 24 to the system 10 wherein the system 10 is configured to write a story based on the uploaded consolidated question(s) and response(s) 24. According to some embodiments, the system 10 can be configured such that the writing/generating of the story is at least partially AI-assisted. For example, according to some embodiments, the story generated by the system 10 based on the consolidated question(s) and response(s) 24 can be generated/drafted via AI. According to some embodiments, this story drafted by AI can then be edited by human(s) before being provided to the user and/or otherwise publicized by the system 10. Further, the system 10 can be configured such that the story generated based on the consolidated question(s) and response(s) 24 is search engine optimized via search engine optimization (SEO). SEO can be performed at least partially via AI and/or any other suitable means. The system 10 is further configured to provide the written story to the user via email and/or any other suitable means. According to some embodiments, a user can approve of or can disapprove of the written story via email and/or any other suitable means. If a user disapproves of the written story, a revision process can occur wherein the system 10 is configured to rewrite at least a portion of the story based on feedback from the user and then provide a rewritten version of the story to the user wherein a user can approve of or disapprove of the rewritten story. This revision process can continue until the user is satisfied.

While FIG. 14 indicates that the story written based on the consolidated question(s) and response(s) 24 will be between 750-1000 words, it is contemplated herein that the story can be any length. The story generation feature 48 can allow a user to upload a photograph in addition to and/or simultaneously with the consolidated question(s) and response(s) 24. This photograph can be a photograph of the user. For example, this photograph could be a military photograph of the user. While FIG. 14 indicates that the photograph to be uploaded should be 10 megabytes (MB) or smaller, it is contemplated herein that the size of the photograph could be other sizes such as larger than 10 MB according to some embodiments. Additionally, while FIG. 14 indicates that the photograph to be uploaded should be horizontal, the photograph could have any orientation according to some embodiments. In order to upload the consolidated question(s) and response(s) 24 and the photograph, the story generation feature 48 can include an upload button 52 and/or any other suitable means for upload. The upload button 52 that is shown in FIG. 14 reads “Select Files”. According to some embodiments, in addition to and/or alternatively to uploading the consolidated question(s) and response(s) 24 and the photograph, a user can email these items to the system 10.

The system 10 is further configured to publish the story and/or photograph via a blog, social media operated by the system 10, and/or on any portion of the system 10. Thus, the story can also be referred to herein as a blog post. According to some embodiments, the system 10 is configured to acquire permission from the user before publicizing the story and/or photograph via a blog, social media, and/or any other means. Details regarding publication of the story and/or photograph can be provided in terms and conditions of use of the system 10. According to some embodiments, a user must agree to said terms and conditions in order to access aspect(s) of the system 10. Publication of a user's story created via the story generation feature 48, the story generation feature 148, and/or a user's story created in any other way allows the user to achieve public recognition for his or her military service and allows others to read the user's story. Achieving recognition for service can help a Veteran achieve clarity and emotional well-being following the Veteran's service. Further, by publishing a Veteran's story such that it can be read and accessed by other Veterans can help those other Veterans deal with their own issue(s) and/or challenge(s) that they face after completing their military service. Thus, publication of a Veteran's story wherein the Veteran is recognized as the author and wherein the published story is accessible by others, including other Veterans, is another example of a therapeutic benefit of the system 10.

The story generation feature 48 can include a video 50 wherein the video 50 describes the story generation feature 48 and/or provides guidance to the user regarding how to interact with the story generation feature 48.

According to some embodiments, the system 10 is configured to include a view, page, and/or portion that displays at least one of the published stories/blog posts. According to some embodiments, this view, page, and/or portion can display many published stories/blog posts that have been written by many different users. Thus, a user can navigate to such a view, page, and/or portion to read and/or access the published stories/blog posts of others. According to some embodiments, the user can access the published stories/blog posts by selecting the “Blog” option via the ribbon of the system 10. The “Blog” option can be selectable via the ribbon 23, the ribbon 27, and/or the ribbon 123.

The story generation feature 48 can further include a checkbox 54 wherein a user can select the checkbox 54 to indicate that the user has provided the consolidated question(s) and/or answer(s) 24 and a photograph to the system 10 via upload, email, and/or otherwise. According to some embodiments, the checkbox 54 is automatically unselected by the system until a user uploads the consolidated question(s) and response(s) 24 and a photograph wherein the checkbox 54 is then automatically selected by the system 10. According to some embodiments, the checkbox 54 must be selected in order for the system 10 to generate a story based on the consolidated question(s) and response(s) 24. Additionally, according to some embodiments, the user must upload the consolidated question(s) and response(s) 24 and a photograph in order for the system 10 to generate a story based on the consolidated question(s) and response(s) 24. The story generation feature 48 can further include a story button 56, and/or any other input means other than a button. The story button 56 can be selected by a user to indicate that the user would like the system 10 to write a story based on the user's submitted consolidated question(s) and response(s) 24. The story button 56 is shown to appear under the checkbox 54 in FIG. 14. According to some embodiments, the system 10 charges the user a fee to write a story and provide said story to the user. In other words, the user can hire the system 10 to write a story and provide the story to the user. According to some embodiments, the system 10 will display a warning message if a user selects the story button 56 without first uploading the consolidated question(s) and response(s) 24 and a photograph.

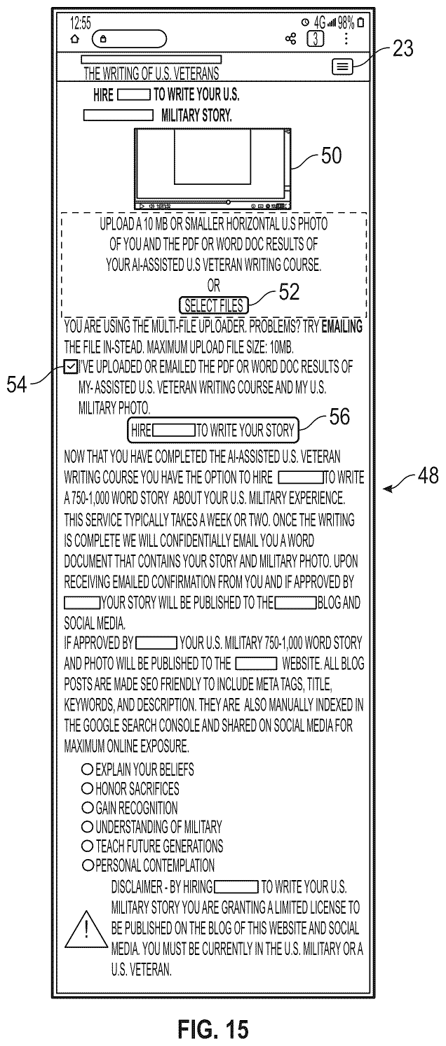

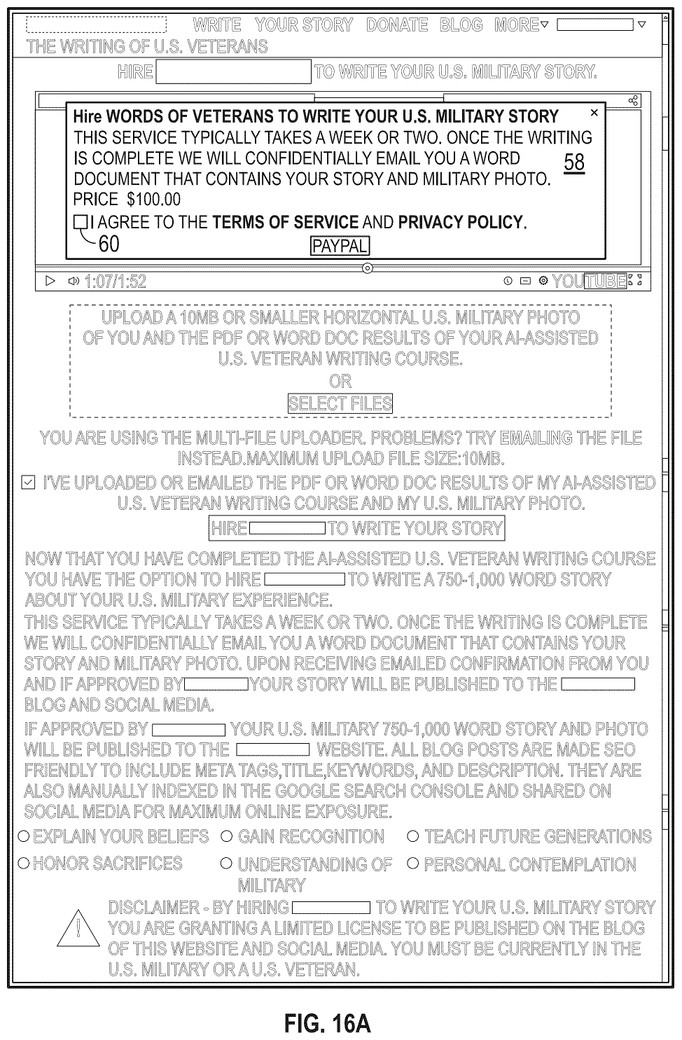

FIG. 15 shows a view of the same aspects of the writing platform system 10 that are included in FIG. 14. FIG. 15 shows the aspects of FIG. 14 in a mobile format rather than in a personal computer format. All aspects of FIG. 14 can be included in FIG. 15 and can function in the same and/or similar manner as described with reference to FIG. 14.

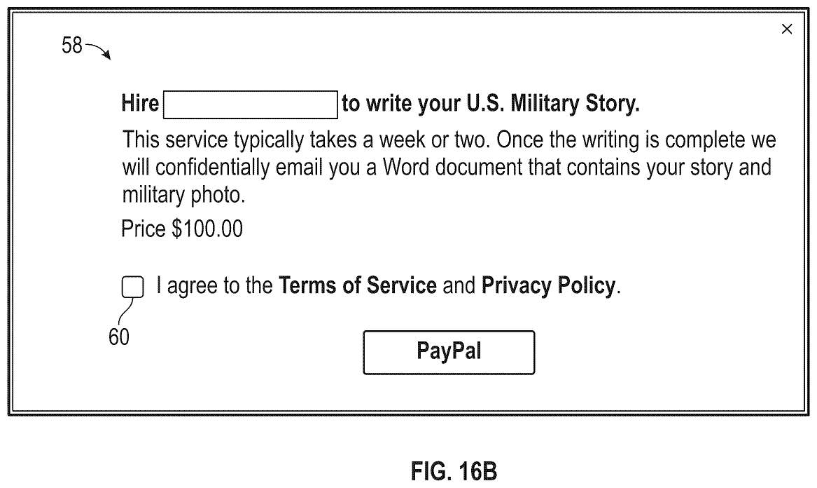

FIG. 16A shows a pop-up window 58 that is associated with the story generation feature 48. The system 10 is configured to display the pop-up window 58 to the user when the user selects the story button 56. The pop-up window 58 provides details regarding generation of the story by the system 10. The pop-up window 58 can include an agreement button 60 as shown in FIG. 16A, which can be a checkbox and/or any other suitable input means, which a user can select to indicate that the user agrees to the terms of service (also referred to as the terms and conditions herein) and/or the privacy policy of the system 10. According to some embodiments, the system 10 will not generate a story, or even provide the option for a user to request to generate a story, unless a user selects the agreement button 60 and/or otherwise accepts the terms of service and/or privacy policy. While FIG. 16A shows the price of using the story generation feature 48 to be $100.00, this price is non-limiting. According to various embodiments, the price of using the story generation feature 48 can be any price and/or can be free.

According to some embodiments, the system 10 is configured to display the pop-up window 58 to the user before allowing a user to access the story generation feature 48. Thus, a user must agree to the terms of service and/or the privacy policy of the system 10 before being able to access the story generation feature 48. According to some embodiments, the story generation feature 48 is not accessible unless the user has agreed to the terms and conditions of the system, created an account, submitted a response to each of the question(s) 13, uploaded the consolidated question(s) and response(s) 24 and a photograph, selected the checkbox 54, and/or confirmed that the uploaded consolidated question(s) and response(s) 24 and photograph are acceptable.

FIG. 16B shows an enlarged view of the pop-up window 58 of FIG. 16A. As shown in FIGS. 16A and 16B, the pop-up window 58 can include a payment option, shown as PayPal in FIGS. 16A and 16B. While PayPal is shown in FIGS. 16A and 16B, any suitable payment method could be included. Additionally, the pop-up window 58 can include a button, shown as an “x” in the top-right corner, to close the pop-up window 58. Additionally or alternatively, according to some embodiments, the pop-up window 58 can include a disclaimer. The disclaimer can include that by hiring the system 10 to generate a story/blog post based on the consolidated question(s) and response(s) 24, the user grants to the system 10 a limited license allowing the story/blog post to be published by the system 10 on the World Wide Web, such as via the system's 10 website, blog, and/or social media. The disclaimer can further include that the user must be currently in the U.S. military or must be a U.S. Veteran. According to various embodiments, this disclaimer can be included on any view and/or portion of the system 10.

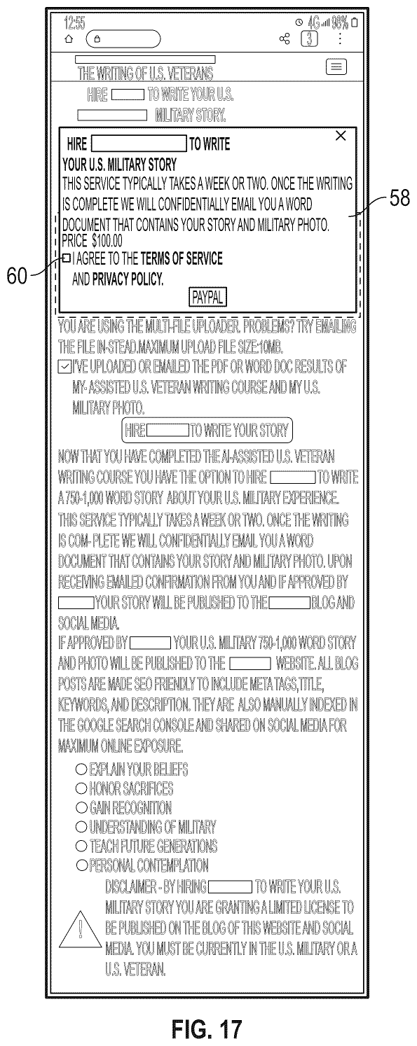

FIG. 17 shows a view of the same aspects of the writing platform system 10 that are included in FIG. 16A. FIG. 17 shows the aspects of FIG. 16A in a mobile format rather than in a personal computer format. All aspects of FIG. 16A can be included in FIG. 17 and can function in the same and/or similar manner as described with reference to FIG. 16A.

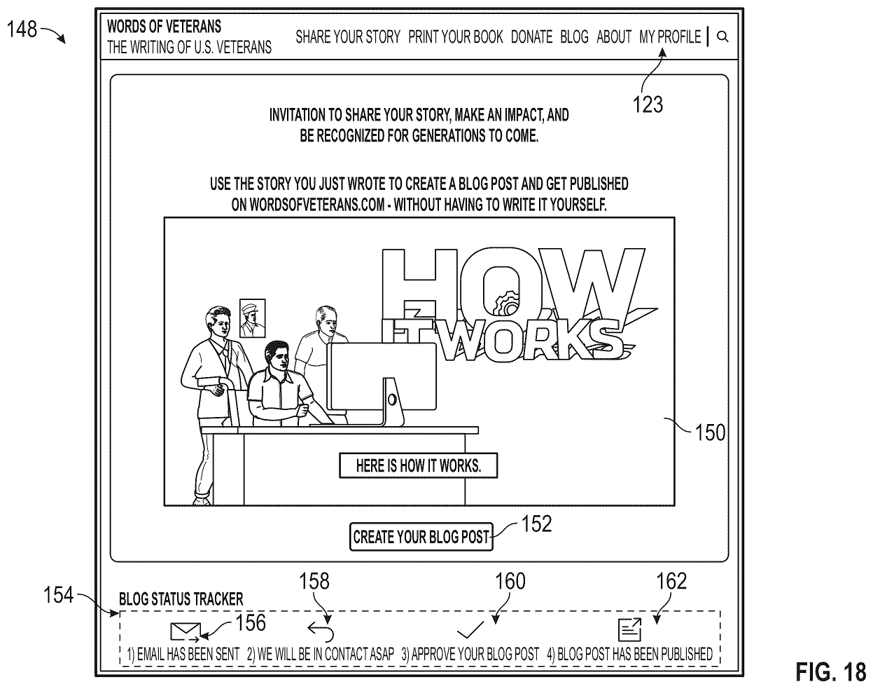

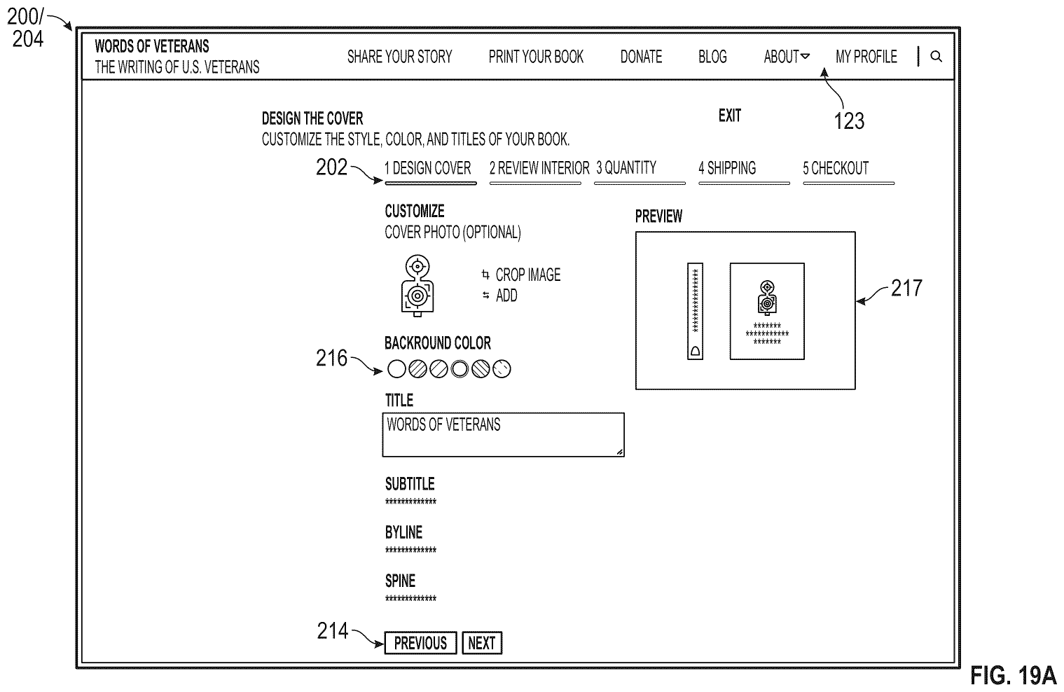

FIG. 18 shows an example view of an embodiment of a story generation feature 148. According to some embodiments, the system 10 can include the story generation feature 148. According to some embodiments, the story generation feature 148 can be the same as and/or similar to the story generation feature 48 and/or can integrate any aspect(s) of the story generation feature 48. The story generation feature 148 can be included in addition to or alternatively to the story generation feature 48.

As shown in FIG. 18, the story generation feature 148 can include an instructional video 150 regarding details about the story generation feature 148 and/or the system 10 in general. According to some embodiments, the video 150 can describe the story generation feature 148 and/or can provide guidance to the user regarding how to interact with the story generation feature 148. Additionally or alternatively, according to some embodiments, the video 150 can include an explanation of the process of story creation via the story generation feature 148 and can include an explanation of the story status tracker 154.

As shown in FIG. 18, the story generation feature 148 can include a story status tracker 154. As shown in FIG. 18, according to some embodiments, the story status tracker 154 can include four different status indications: (1) a first status indication 156 that an email has been sent, (2) a second status indication 158 that the system 10 will be in contact with the user, (3) a third status indication 160 that the final story/blog post is ready for approval by the user, and (4) a fourth status indication 162 that the story/blog post has been published.

As shown in FIG. 18, the story generation feature 148 can include a creation button 152. While the creation button 152 is shown to be a button in FIG. 18, the creation button 152 can take the form of any suitable input means according to various embodiments. In FIG. 18, the creation button 152 is shown to read “Create Your Blog Post”, but, according to various embodiments, the creation button could include any suitable text such as “Create Your Story” and the like. According to some embodiments, the creation button 152 is only enabled and available for a user to select if the user has met two conditions: (1) the user must have answered each question of the list of questions 13, and (2) the total word count of the user's answers to the questions 13 must be greater than 1000 words. According to some embodiments, if either of these two criteria (i.e., providing answers to all the questions 13 and having a total word count of the responses to the questions 13 be greater than 1000 words) are not achieved, the creation button 152 can be disabled such that it cannot be selected. If the creation button 152 is disabled, the user can go back and submit additional information and/or provide updates to information already submitted to meet both criteria in order to enable the creation button 152. Alternatively, according to some embodiments, the creation button 152 is always enabled, and if a user selects the creation button 152 without meeting either of the two criteria (i.e., providing answers to all the questions 13 and having a total word count of the responses to the questions 13 be greater than 1000 words) the system 10 can be configured to provide an error message wherein the error message can include an explanation of the error and/or an explanation regarding how to remedy the error.

The user can select the creation button 152 to command the system 10 to create an AI-generated story/blog post based on the user's consolidated question(s) and answer(s) 24. Such story creation can be the same as and/or similar to that described herein regarding the story generation feature 48. After the user selects the creation button 152, the user can then provide payment via the system 10. After selecting the creation button 152, the system 10 is configured to display a pop-up window, such as the pop-up window 58, wherein a user can provide payment and must agree to any terms of service and/or privacy policy of the system 10. Such a pop-up window can include the disclaimer noted above regarding some embodiments of the pop-up window 58. Payment can be made securely via the system 10 using any suitable form of payment method such as PayPal, Apple Pay, credit card, debit card, and the like. After submitting payment, the system 10 is configured to send an email to the user containing a first draft of the story/blog post. According to some embodiments, if the total character count of the user's answers to the questions 13 is over 16,000, the system 10 is configured to contact the user (via email, Google Docs, and/or any other suitable means) to work in conjunction with the user to edit the user's answers down so that the total character count is equal to or less than 16,000 before generating the first draft of the story/blog post. According to some embodiments, the first status indication 156 of the story status bar 154 that an email has been sent can be indicated to be complete after the first draft of the story/blog post has been sent to the user. According to some embodiments, the total number of characters of the user's response(s) to the question(s) 13 can be greater than 16,000.

After sending the email with the first draft of the story/blog post, the system 10 can be configured to review the story/blog post and contact the user (via email, Google Docs, and/or other suitable method) to provide prompts for revisions and/or to obtain more information. According to some embodiments, the second status indication 158 of the story status bar 154 that the system 10 will be in contact with the user can be indicated to be complete when the system 10 has sent the first draft of the story/blog post to the user and is preparing to review the first draft of the story/blog post and contact the user, via email, Google Docs, or otherwise, to provide prompts for revision and/or to ask the user for more information. If the story/blog post contains any illegal content, the system 10 is configured to provide the user with a refund and/or indicate to the user that the user will not be able to use the system 10 to create a story/blog post.

The system 10 is configured to then allow the user to communicate with the system 10 regarding the story/blog post. Such communication can involve commenting on and/or accepting any revisions suggested by the system 10 and/or anything else related to the story/blog post. According to some embodiments, if revision is required, the system 10 is configured to direct the user to a Google Docs collaboration link wherein the system 10 and user can edit the story/blog post jointly. Additionally, during this joint revision process, the system 10 can allow the user to send (via email, Google Docs, and/or otherwise) and/or upload an image to be incorporated into the story/blog post. If the user does not send and/or upload an image, the system 10 can be configured to use a generic image such as a copyright-free image of an American flag. After the user has had at least one opportunity to communicate and/or work jointly with the system 10 regarding the story/blog post (e.g., jointly edit the story/blog post via Google Docs), the system 10 can be configured to then send the user a final draft of the story/blog post for approval by the user and/or ask the user to approve the jointly edited final draft of the story/blog post. According to some embodiments, the third status indication 160 of the story status bar 154 that the final draft of the story/blog post is ready for approval by the user can be indicated to be complete when necessary and/or desired edits to the story/blog post have been completed and/or additional information has been submitted (such as an image) such that the story/blog post is in a final draft form.

The user can then choose to approve the final draft via email and/or any other suitable means including, but not limited to, Google Docs. According to some embodiments, the system 10 can prompt the user to agree to a disclaimer before being able to approve the final draft of the story/blog post. According to some embodiments, the disclaimer can be presented to the user via email and/or any other suitable means before, during, and/or after editing of the story/blog post occurs. According to some embodiments, the disclaimer can include that the user grants to the system 10 a limited license allowing the story/blog post to be published by the system 10 on the World Wide Web, such as on the system's 10 website, blog, and/or social media. Additionally or alternatively, according to some embodiments, the disclaimer can include an indication that the user retains copyright rights in the story/blog post. Additionally or alternatively, according to some embodiments, the disclaimer can include that the user must affirm that the user is currently in the U.S. military or is a U.S. Veteran and/or that the user understands that the system 10 is available only for current U.S. military members or U.S. Veterans. Additionally or alternatively, according to some embodiments, the disclaimer can include that the system 10 will remove the story/blog post from the system's 10 website, blog, and/or social media upon request by the user. According to various embodiments, this disclaimer can be included on any view and/or portion of the system 10. If the user approves the final draft of the story/blog post, the system 10 is configured to publish the story/blog post such that it is available on the World Wide Web. According to some embodiments, such publication can occur, for example, on the system's 10 website, blog, and/or social media. According to some embodiments, after publishing the story/blog post, the system 10 is configured to send a thank you email to the user. According to some embodiments, upon publishing the story/blog post, the system 10 is configured to perform search engine optimization (SEO) for the story/blog post. Such SEO can be performed as described herein and/or via any known means in the art. For example, according to some embodiments, the system 10 can utilize Google Analytics for SEO purposes. According to some embodiments, the system 10 can use backlink(s) via relevant websites with high domain authority. According to some embodiments, such backlink(s) are configured starting with 3,000 long tail keywords, however, many more long tail keywords could be used and/or targeted. According to some embodiments, SEO practices, such as those described herein and/or any known in the art, can be used for the system 10 in general. According to some embodiments, the fourth status indication 162 of the story status bar 154 that the story/blog post has been published can be indicated to be complete when the story/blog post has been published by the system 10 via the World Wide Web.

As noted, according to some embodiments, the system 10 can use AI, which can include ChatGPT, to generate the story/blog post. The story/blog post can be based on the consolidated question(s) and response(s) 24. The system 10 can utilize AI by prompting the AI only once with all of the user's response(s) to the question(s) 13 and/or all of the consolidated question(s) and answer(s) 24 rather than prompting the AI multiple times such as prompting the Al separately for each response to each question 13. By prompting the AI only once during story/blog post generation rather than multiple times, the system 10 can be more computationally efficient and more energy efficient. According to some embodiments, the AI can be prompted more than once during generation of the story/blog post. According to some embodiments, the AI can be trained with and/or can already be aware of each of the question(s) 13. Therefore, when the AI is prompted with the user's response(s) to each of the question(s) 13, the AI can create a story/blog post effectively and efficiently.

According to some embodiments, the system 10 can allow users to subscribe to notifications regarding published stories/blog posts. For example, the system 10 can be configured to send a notification to a subscribed user each time the system 10 publishes a story/blog post via the system's website, blog, and/or social media. Such notifications can be browser web push notifications and/or can be in any other suitable form such as via email. Browser web push notifications can be sent via desktop or mobile web platforms.

According to some embodiments, the story generation feature 148 can include promotional material including, but not limited to, a banner advertising a discounted price such as a $15.00 discount.

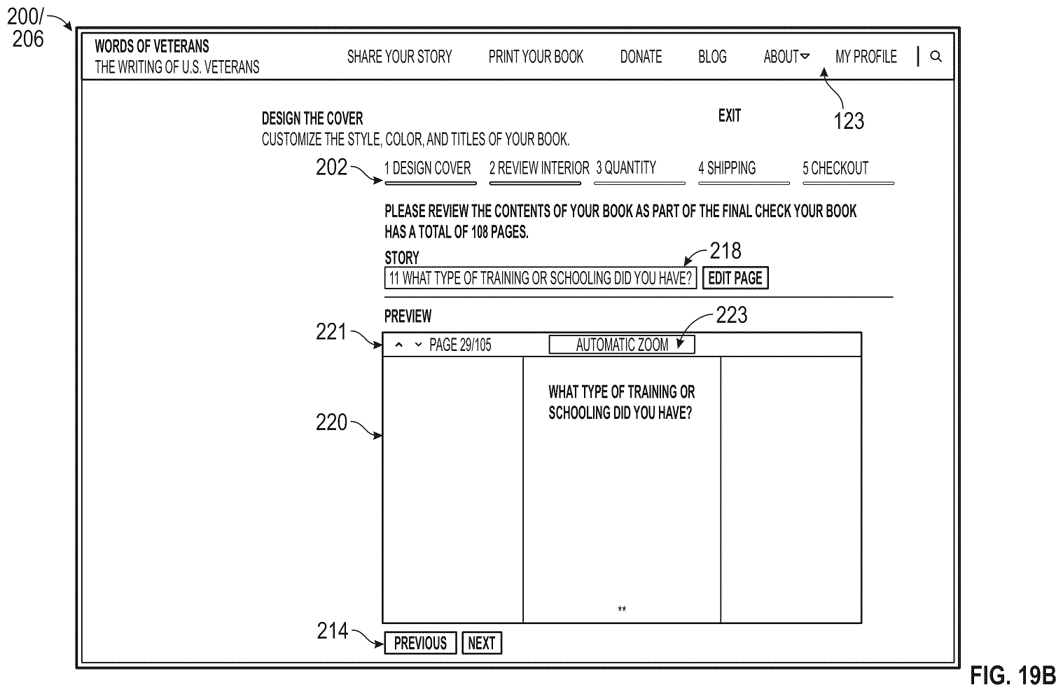

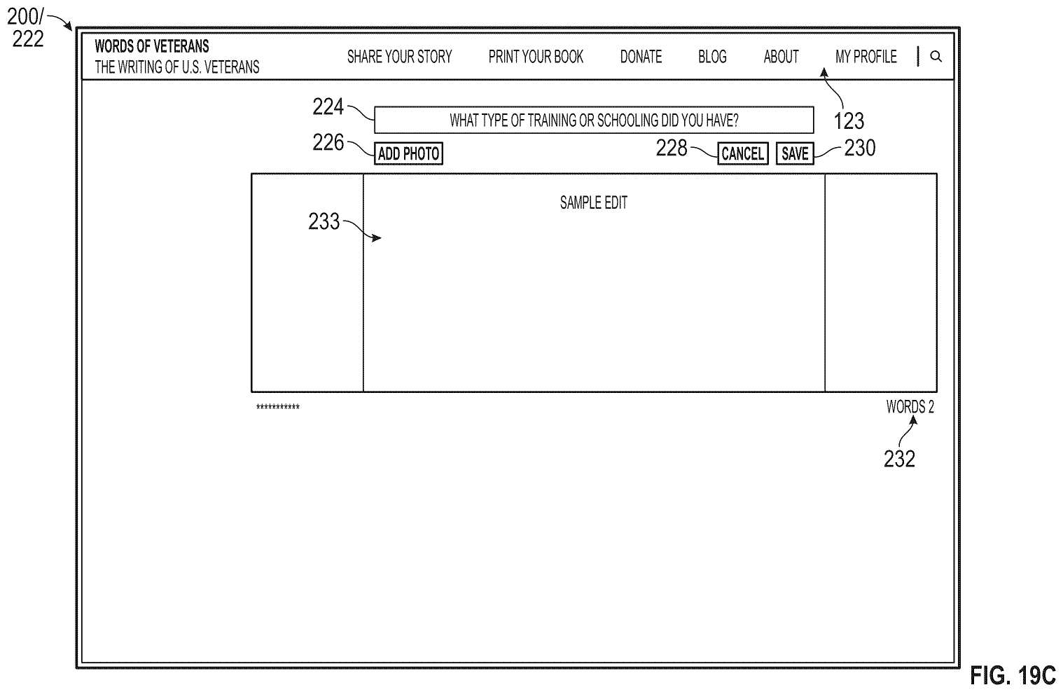

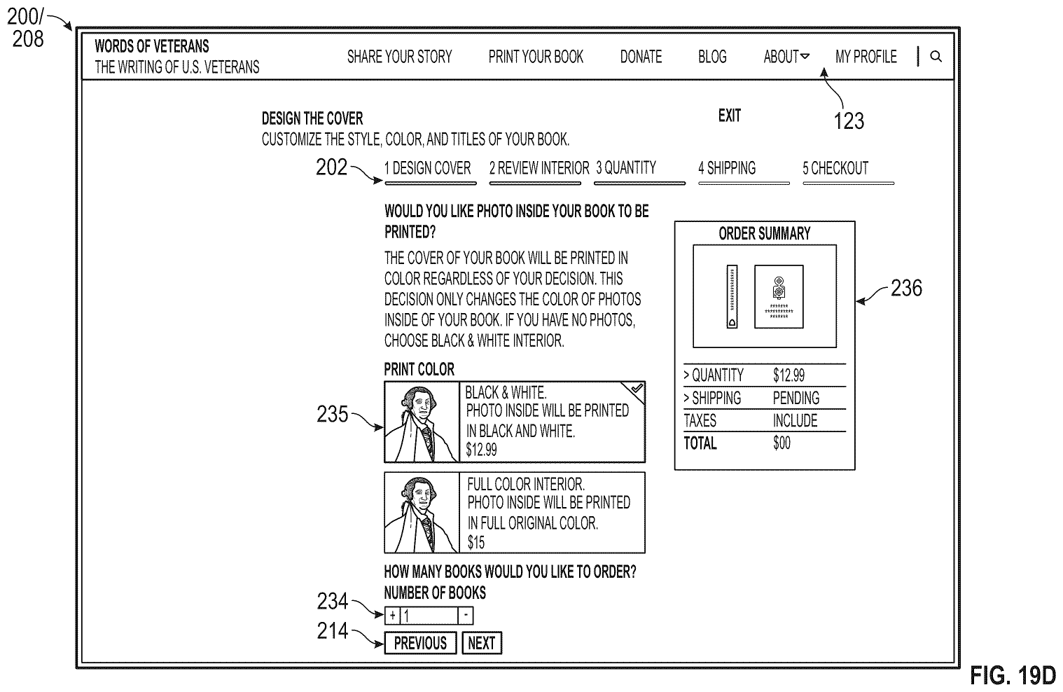

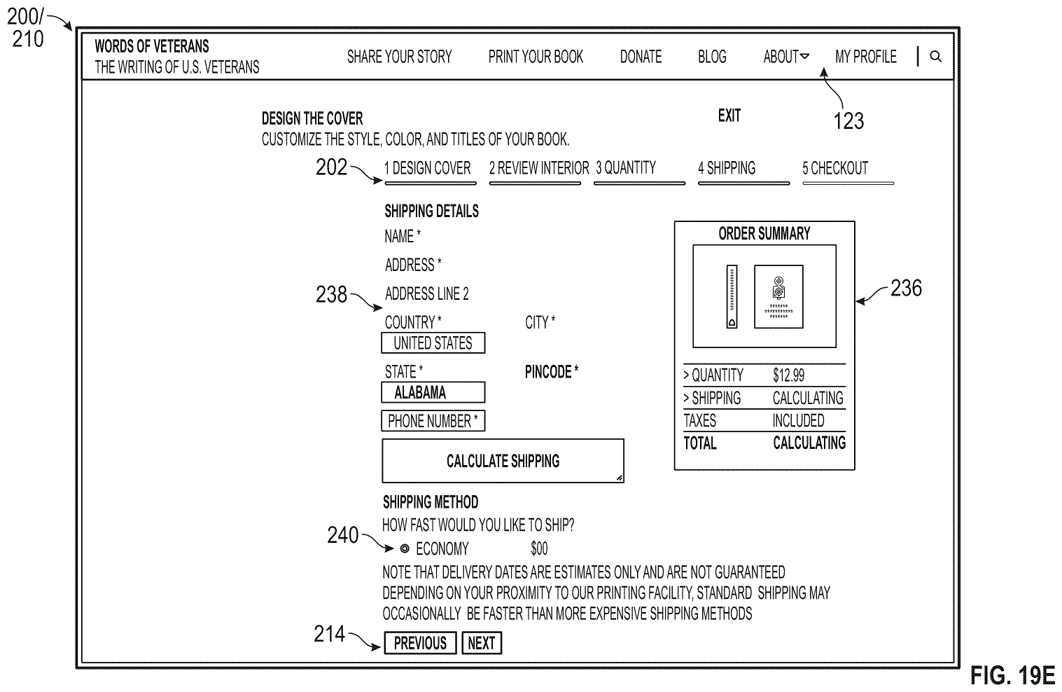

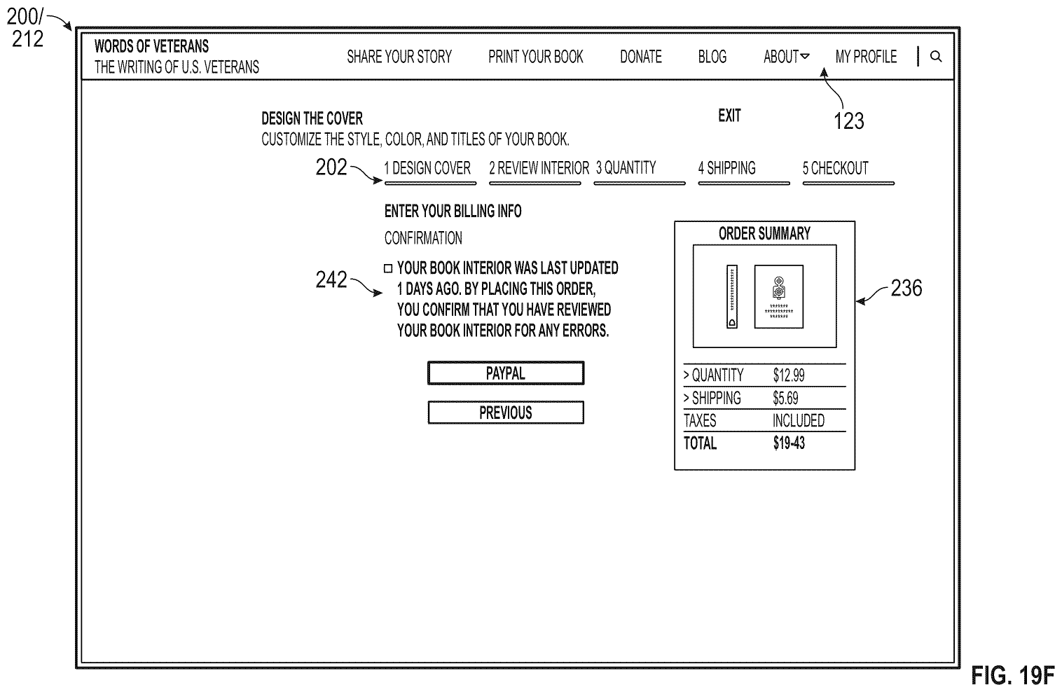

FIG. 19A shows a view of a book creation feature 200. According to some embodiments, the book creation feature 200 is included as part of the system 10. The book creation feature 200 can include the ability to allow a user to create and print a book wherein the book includes the final draft of the story/blog post and/or the consolidated question(s) and answer(s) 24. As shown in FIG. 19A, the book creation feature 200 can include a book creation progress bar 202 that includes several aspects of the book creation feature 200 including: (1) a Design Cover capability 204 that allows a user to design the exterior of the book; (2) a Review Interior capability 206 that allows a user to review and edit the interior of the book; (3) a Quantity capability 208 that allows a user to decide how many copies of the book are to be printed and also allows a user to decide whether images printed inside the book are to be black-and-white or color; (4) a Shipping capability 210 that allows a user to specify shipping information; and (5) a Checkout capability 212 that allows a user to specify payment information and provide payment for the book. The book creation progress bar 202 can indicate to a user at what step in the process the user is currently at regarding the creation of a book. FIG. 19A shows an example view of the book creation feature 200 showing the Design Cover capability 204.

As shown in FIG. 19A, the book creation feature 200 can further include book creation navigation buttons 214. As shown in FIG. 19A, the book creation navigation buttons 214 can include a “Previous” button that, when selected, allows a user to navigate to a previous step of the book creation feature 200. As shown in FIG. 19A, the book creation navigation buttons 204 can include a “Next” button that, when selected, allows a user to navigate to the next step of the book creation feature 200. While the book creation feature navigation buttons 214 are shown to be buttons in FIG. 19A, any suitable input means could be used.

As shown in FIG. 19A, the Design Cover capability 204 can include exterior customization options 216 and a preview 217. The exterior customization options 216 allow a user to customize the exterior of the book. According to some embodiments, the user can customize an image to be included on the cover of the book (including the ability to crop the image) a background color of the book, a title of the book, a subtitle of the book, a byline of the book, and text appearing on the spine of the book. While some of the customization options 216 are shown in FIG. 19A to include text field(s) for inputting information, any suitable input means could be used for each option of the customization options 216 including, but not limited to, text field(s), voice input, and the like. As shown in FIG. 19A, the system 10 is configured to allow a user to upload an image to be included on the cover of the book. As shown in FIG. 19A, the system 10 is configured to allow a user to choose between a variety of background colors. While the background color options shown in FIG. 19A are shown to include different patterns, the options of background colors can include different solid colors and can include any suitable colors. For example, according to some embodiments, a user can choose from a variety of colors including, but not limited to, green, brown, light blue, silver, navy blue, and orange. In this example, each color can correlate to a branch of the U.S. military wherein green correlates to the U.S. Marine Corps, brown correlates to the U.S. Army, light blue correlates to the U.S. Air Force, silver correlates to the U.S. Space Force, navy blue correlates to the U.S. Navy, and orange correlates to the U.S. Coast Guard. As shown in FIG. 19A, the preview 217 can show a rendering of the exterior of the book based on the user's specifications regarding the customization options 216. The preview 217 can be configured to update in substantially real time based on the user's specifications regarding the customization options 216.

FIG. 19B shows another view of the book creation feature 200. FIG. 19B shows a view of the book creation feature 200 showing the Review Interior capability 206. As shown in FIG. 19B, the Review Interior capability 206 can include a question navigation bar and editing button 218. As shown in FIG. 19B, the Review Interior capability 206 can include a preview feature 220 that displays any portion of the book to allow a user to preview said portion of the book. The Review Interior capability 206 can display the total number of pages of the book. The preview feature 220 can include buttons 221, and/or other input means, to navigate to a particular page of the book. The preview feature 220 can include a zoom option 223 that allows a user to specify the level of zoom of the portion of the book displayed via the preview feature 220. For example, the user can choose automatic zoom, actual size, page fit, page width, 50% zoom, 75% zoom, 100% zoom, 125% zoom, 150% zoom, and/or any other suitable zoom level. The question navigation bar and editing button 218 can include a drop-down menu wherein the drop-down menu includes each question of the list of questions 13 and also includes an option for Table of Contents. The user can use the question navigation bar and editing button 218 to navigate to any portion of the book by selecting a particular question from the list of question(s) 13 and/or selecting to navigate to the Table of Contents. When a user selects a particular question, the preview feature 220 can navigate to the portion of the book containing that question so that the user can preview that portion which contains that particular question and the user's answer to that question. The question navigation bar and edit button 218 can include a button that, when selected, allows a user to edit a particular page of the book. According to some embodiments, when the edit button of the question navigation bar and edit button 218 is selected, the system 10 navigates to a page editing feature 222 which is shown in FIG. 19C. According to some embodiments, a user cannot change the order of the question(s) 13 displayed via the question navigation bar and editing button 218.

FIG. 19C shows a view of a page editing feature 222 that can be included as part of the book creation feature 200 and/or the system 10. As shown in FIG. 19C, the page editing feature 222 can include a question 224, an add photo option 226, a cancel option 228, a save option 230, a word count 232, and a text input area 233. The question 224 can be the question to which the user navigated to edit the user's response. The photo option 226 can allow a user to include a photo with the user's response to the question 224. The cancel option 228 allows a user to cancel any edits that were entered. The cancel option 228 reverts back to the last saved response to the question 224. The save option allows a user to save any edits that were entered in response to the question 224, such that these edits will appear in the book. The word count 232 displays how many words the response to the question 224 includes. The text input area 233 can be a text field and/or any other suitable input means, wherein a user can edit the user's response to the question 224. Additionally or alternatively, according to some embodiments, the system 10 is configured to allow a user to edit the user's response to the question 224 via voice and/or audio input.

FIG. 19D shows another view of the book creation feature 200. FIG. 19D shows a view of the book creation feature 200 showing the Quantity capability 208. As shown in FIG. 19D, the Quantity capability 208 can include an interior image customization portion 235 that can provide the ability for a user to choose whether images appearing inside the book are shown in black-and-white or in color. The Quantity capability 208 can include a quantity option 234 that allows a user to specify the number of copies of the book to be produced. As shown in FIG. 19D, the quantity option 234 can include a button with a “+” to increase the quantity of books to be produced, and the quantity option 234 can include a button with a “−” to decrease the quantity of books to be produced. Additionally or alternatively, the quantity option 234 can include a text field wherein a user can specify a specific quantity of books to be produced via typing in the text field and/or via voice and/or audio input. The Quantity capability 208 can include an order summary 236 that can display cost associated with the quantity of books to be produced, cost associated with shipping, cost associated with taxes, and total cost. The order summary 236 can be configured to update in substantially real time based on the specified quantity of books to be produced.

FIG. 19E shows another view of the book creation feature 200. FIG. 19E shows a view of the book creation feature 200 showing the Shipping capability 210. The Shipping capability 210 can include shipping details 238, shipping method 240, and the order summary 236. The shipping details 238 can allow a user to enter shipping information via text fields, drop-down menus, and/or any other suitable input means including, but not limited to, voice and/or audio input. The shipping details 238 can include name, address, country, state, city, zip code, and/or phone number. The shipping method 240 can include the ability for a user to select the shipping method that the user desires. The shipping method can include different methods of shipping wherein some methods are faster or slower and/or more expensive or less expensive. The shipping details 238 can further include a button that, when selected, calculates shipping cost based, at least in part, on the information included in the shipping details 238 in combination with the user's selection regarding the shipping method 240. The order summary 236 can update in substantially real time to reflect shipping cost.

FIG. 19F shows another view of the book creation feature 200. FIG. 19F shows a view of the book creation feature 200 showing the Checkout capability 212. The Checkout capability 212 can include billing information 242 and the order summary 236. The billing information 242 can include allowing a user to enter billing information via text field(s), drop-down menu(s), and/or any other suitable input option(s) including, but not limited to, voice and/or audio input. According to some embodiments, as shown in FIG. 19F, the billing information 242 can allow a user to provide payment via PayPal. According to various embodiments, the billing information 242 can allow a user to provide payment via any suitable payment method such as PayPal, Apple Pay, credit card, debit card, and the like. Again, the order summary 236 is configured to update in real time based on selections by the user based on quantity of books to be produced, shipping specifications, and tax implications.

As shown in FIGS. 18-19F, according to various embodiments, a ribbon 123 having different selectable options than the ribbon 23 or the ribbon 27 can be included as part of the system 10. For example, as shown in FIGS. 18-19F, the ribbon 123 can include selectable options including, but not limited to, “Share Your Story”, “Print Your Book”, “Donate”, “Blog”, “About”, “My Profile”, and a magnifying glass that allows a user to search throughout the system 10. The ribbon 123 can operate in the same and/or similar manner as the ribbon 23, the ribbon 27, and/or any other ribbon described herein. For example, the ribbon 123 can be used to navigate to aspects of the system 10. As shown in FIGS. 18-19F, at least some embodiments that include the ribbon 123 can also include the selectable option for a user to exit the system 10.

According to some embodiments, the book creation feature 200 can include a messaging widget. The messaging widget can be included in one or more of the portions of the book creation feature 200 including the Design Cover capability 204, the Review Interior capability 206, the Quantity capability 208, the Shipping Capability 210, and/or the Checkout capability 212. According to some embodiments, the messaging widget can function as a chatbot wherein the messaging widget can be used for communication between the user and the system 10. The messaging widget can allow a user to provide input to the messaging widget. The messaging widget can include a text input area wherein a user can type into the text input area to provide input to the messaging widget. Additionally or alternatively, according to some embodiments, the system 10 can be configured to allow a user to provide voice, speech, and/or audio input to the messaging widget. The messaging widget can be configured to provide and/or display generic input that a user can quickly and easily select such as input including, but not limited to, “I have a question”, “What can you do?”, and the like. The messaging widget is configured to provide output based on the input provided by the user. The messaging widget can include a text output area wherein the messaging widget can provide output by outputting and/or displaying text via the text output area. Additionally or alternatively, according to some embodiments, the system 10 is configured so that the messaging widget can provide audio output. The messaging widget can be used by a user to interact with the system 10 in any suitable manner including, but not limited to, asking a question regarding the system 10 and/or an aspect thereof, providing a comment to the system 10, and the like. The messaging widget can be configured to provide output in response to the user's input such as by answering a user's question, acknowledging a user's comment, and the like. Additionally or alternatively, according to some embodiments, the messaging widget can provide output unprompted. Such unprompted output could include, but is not limited to, asking the user if the user needs anything, pricing information and/or discounts, new features of the system 10, navigational and/or other information regarding aspect(s) of the system 10, announcements regarding the system 10, instructions and/or information regarding how to proceed with aspect(s) of the system 10, and the like. According to some embodiments, the messaging widget can be automated and can include AI to generate the output. Additionally or alternatively, according to some embodiments, the messaging widget can be controlled via a human individual associated with the system 10 wherein that individual provides the output via the messaging widget. The messaging widget serves to improve the speed and case with which a user uses aspect(s) of the system 10. According to some embodiments, the messaging widget can be configured to test and/or assess a user's uploaded image to determine how well the image will print via the created book. The messaging widget can be configured to output information regarding how well the image will print via the created book. The messaging widget can assess factors of an uploaded image including, but not limited to, resolution, dimensions, format, file type, color mode, DPI (dots per inch), and/or color quality. According to some embodiments, other aspect(s) of the system 10 other than the messaging widget can be used to perform the testing and/or assessment of a user's uploaded image. According to some embodiments, the testing and/or assessment of a user's uploaded image can include the use of ChatGPT. According to some embodiments, the system 10 can be configured to provide and/or display a warning (which could be embodied as a pop-up message and/or any other type of message) regarding the testing and/or assessment of the uploaded image wherein the warning includes a statement indicating whether or not the uploaded image will print properly and/or indicating a likelihood relating to whether or not the uploaded image will print properly. Additionally or alternatively, according to some embodiments, the system 10 can provide and/or display a second warning when a user attempts to create and/or print a book if a printing issue, such as an issue with an uploaded image, is determined to exist. According to some embodiments, the second warning can be embodied in a pop-up message and/or any other type of message. The second warning can include text asking if the user is sure that he or she wants to proceed with creating and/or printing a book even though at least one printing issue is identified, such as an issue with at least one uploaded image, wherein the second warning further includes a selectable option for a user to proceed with creation and/or printing of a book. Additionally or alternatively, according to some embodiments, the warning can include a button, and/or other selectable input means, that a user must select before creating and/or printing the book wherein the button, and/or other input means, comprises an acknowledgement by the user that the user is choosing to create and/or print the book even though at least one printing issue, such as an issue with one or more uploaded images, is identified. According to some embodiments, ChatGPT can be used with any suitable aspect(s) of the system 10 including any aspect(s) that utilize AI.

According to some embodiments, the messaging widget and the AI widget 18 can be operationally connected such that the messaging widget and the AI widget 18 can operate using the same AI. In other words, the AI widget 18 and the messaging widget can learn together via AI and/or can share intelligence. Thus, any input, including words, images, and/or any other input, that is input into the AI widget 18 can be used by the messaging widget to learn and/or can be shared with the messaging widget. Also, any input, including words, images, and/or any other input, that is input into the messaging widget can be used by the AI widget 18 to learn and/or can be shared with the AI widget 18. According to some embodiments, the system 10 can include a nested AI widget. The nested AI widget can utilize ChatGPT. The nested AI widget can be operationally connected to the AI widget 18 and/or the messaging widget. Thus, input into any of the AI widget 18, messaging widget, and/or nested AI widget can be used by any of the other widgets and/or AI aspect(s) of the system 10 to learn and/or can be shared with any of the other widgets and/or AI aspect(s) of the system 10.

According to some embodiments, the system 10 can include a multi-agent persona AI agent. The AI included as part of the system 10 can create and/or develop the multi-agent persona AI agent. The multi-agent persona AI agent can include a U.S. Veteran persona, a member of the U.S. military persona, and/or any other suitable persona. According to some embodiments, the different personas of the multi-agent persona AI agent, such as the U.S. Veteran persona or the U.S. military member persona, can be configured to mimic a real U.S. Veteran or real U.S. military member and/or to provide output similar to output that would be provided by a real U.S. Veteran or real member of the U.S. military. The multi-agent persona AI agent can be operationally connected to any aspect(s) of AI of the system 10 including, but not limited to, the AI widget 18, the messaging widget, the nested AI widget, story/blog post generation, and/or book creation. According to some embodiments, the multi-agent persona AI agent can be and/or comprise the AI aspect(s) of the system 10 including, but not limited to, the AI widget 18, the messaging widget, the nested AI widget, story/blog post generation, and/or book creation. Thus, the multi-agent persona AI agent can learn via and/or share intelligence with any suitable aspect of the system 10 including, but not limited to, the AI widget 18, the messaging widget, the nested AI widget, story/blog post generation, and/or book creation. The multiple personas of the multi-agent persona AI agent can work together to formulate and/or provide effective and/or complex output. Said output can be provided via any suitable aspect of the system 10 including, but not limited to, the AI widget 18, the messaging widget, the nested AI widget, story/blog post generation, and/or book creation. According to some embodiments, the multi-agent persona AI agent can provide emotional support, can be used to obtain therapy, and can be able to indefinitely articulate the likeness, stories, and emotions from data of U.S. military members and U.S. Veterans saved on a server upon which the system 10 can be hosted. Such data of U.S. military members and U.S. Veterans can be that which is input by users.

It is noted that for any text field(s) included as part of the system 10 and/or for any portion(s) of the system 10 wherein information can be entered by the user, according to some embodiments, the system 10 is configured to allow a user to fill such text field(s) and/or enter such information via voice and/or audio input.

It is noted that any pricing information and/or sales copy text shown in any of FIGS. 18-19F is simply for example purposes and is non-limiting.

Any apparatus, system, and/or method described herein, including the system 10, may also provide options to re-publish or print the story through other sources, and/or for the sale of the story. Any apparatus, system, and/or method described herein, including the system 10, may also be adapted to provide financial incentives and/or rewards to the story writers. For example, any apparatus, system, and/or method described herein, including the system 10, may charge a fee to read a story or book, and the fee may be directed, in whole or in part, to the story writer.

It is noted that the system 10, can be configured to be secure and to maintain the privacy of users. According to some embodiments, the system 10 can utilize one or more protection and/or cybersecurity measures that are designed to protect against malware, computer virus(es), cyber attack(s), and the like. Additionally, the system 10 can be configured to utilize one or more measures to manage security.

It should be appreciated that while only some aspects of the system 10 are shown in both a personal computing format and in a mobile format via, any and all aspects of the system 10 are capable of being implemented in a personal computing format and/or in a mobile format.

Each of FIGS. 1 and 3-17 include at least one instance wherein text is obstructed and is shown as a blank rectangle wherein it seems that text should appear. Except for the obstructed portion of the ribbon 23 shown next to the word “More” (shown as a blank rectangle) in FIGS. 1, 4, 8, 9, 12-14, and 16A, each obstructed portion can be read to refer to the system 10.

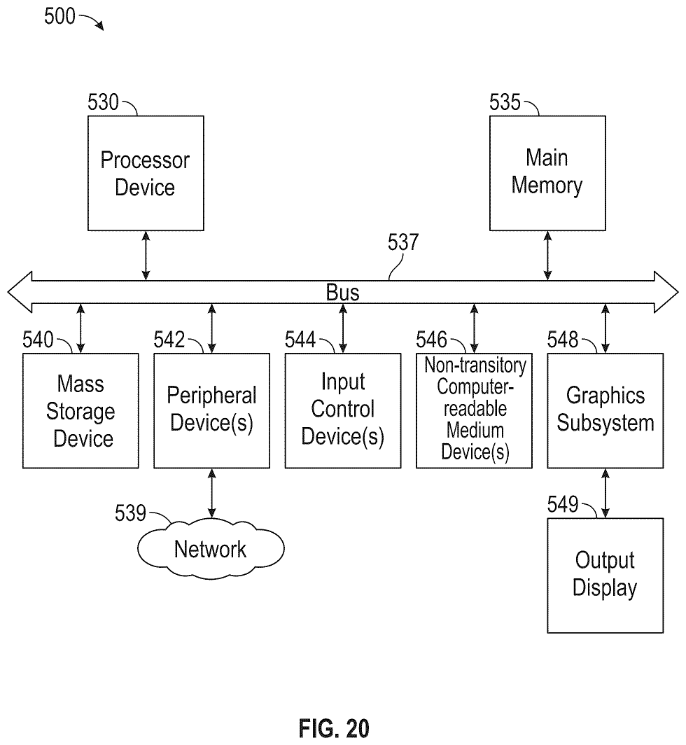

FIG. 20 shows a block diagram of a cyberinfrastructure 500, which may be a general-purpose computing device that can be transformed into a special-purpose computing device, in accordance with at least some embodiments of the system 10 disclosed herein. The cyberinfrastructure 500 may be implemented as a conventional computer system, an embedded controller, a laptop, a server, a mobile device, a smartphone, a tablet, a wearable computer, a set-top box, a kiosk, a vehicular information system, one or more processors associated with a television, a customized machine, any other hardware platform, or any combination or multiplicity thereof. The cyberinfrastructure 500 may be a distributed system configured to function using multiple computing machines interconnected via a data network or bus system.

The cyberinfrastructure 500 may include, without limitation, a processor 530, a graphics processing unit (GPU), Application Specific Integrated Circuit (ASIC), or any combination thereof. The cyberinfrastructure 500 may also include a main memory 535 and an interconnect bus 537. The processor 530 may include, without limitation, a single microprocessor or may include a plurality of microprocessors for configuring the cyberinfrastructure 500 as a multi-processor system.

The processor 530 may be configured to execute code or instructions (e.g., executable instructions) to perform the operations and functionality of the system 10 described herein and/or any other method(s), process(es), and/or algorithm(s) described herein, manage request flow and address mappings, and/or perform calculations and generate commands. The executable instructions, when loaded into the processor 530 and executed, may transform the cyberinfrastructure 500 from a general-purpose computing device into a special-purpose computing device customized to facilitate run-time implementation of any aspect(s) of the system 10. The processor 530 may be configured to monitor and control the operation of the components in the cyberinfrastructure 500. The processor 530 may be and/or comprise a general purpose processor, a processor core, a multiprocessor, a reconfigurable processor, a microprocessor, a microcontroller, a digital signal processor (“DSP”), an application specific integrated circuit (“ASIC”), a graphics processing unit (“GPU”), a field programmable gate array (“FPGA”), a programmable logic device (“PLD”), an arithmetic logic unit (“ALU”), a controller, a state machine, gated logic, discrete hardware components, a central processing unit (“CPU”), and/or any other processing unit, or any combination or multiplicity thereof.

The processor 530 may be and/or comprise a single processing unit, multiple processing units, a single processing core, multiple processing cores, special purpose processing cores, co-processors, or any combination thereof. According to some embodiments, the processor 530 along with other components of the cyberinfrastructure 500 may be a virtualized computing machine executing within one or more other computing machines. The processor 530 can be and/or comprise an intelligent control according to some embodiments.

The main memory 535 stores, among other things, instructions and/or data for execution by the processor 530. For example, according to some embodiments, executable instructions that, when executed by the processor 530 or another component, perform the operations and/or functionality of the system 10 and/or any other method(s), process(es), and/or algorithm(s) described herein can be stored on the main memory 535. Encoding such executable instructions on the main memory 535 may transform the physical structure of the main memory 535. The main memory 535 may include random access memory (“RAM”) such as banks of dynamic random-access memory (DRAM), as well as cache memory. Other examples of memory that could be included as part of the main memory 535 include, but are not limited to, static RAM (“SRAM”), synchronous DRAM (“SDRAM”), etc. According to some embodiments, the main memory 535 can comprise read-only memory (“ROM”, an example of non-volatile memory). Further examples of non-volatile memory that can be included as part of the main memory 535 include, but are not limited to, electrically erasable programmable read only memory (“EEPROM”), flash memory, hard disks, SD cards, and the like.

The cyberinfrastructure 500 may further include mass storage device(s) 540, peripheral device(s) 542, input control device(s) 544, non-transitory computer-readable medium device(s) 546 (e.g., non-transitory computer-readable storage media), a graphics subsystem 548, and/or a display 549. For explanatory purposes, all components in the cyberinfrastructure 500 are shown in FIG. 20 as being coupled through bus 537 wherein the bus 537 can be any suitable connection element such that all components of the cyberinfrastructure 500 can be in communication with each other. However, the cyberinfrastructure 500 is not so limited. Devices and systems of the cyberinfrastructure 500 may be coupled through one or more data transport means. For example, the processor 530 and/or the main memory 535 may be coupled through a local microprocessor bus. The mass storage 540, peripheral device(s) 542, non-transitory computer-readable medium device(s) 546 (which could include portable storage medium device(s) according to some embodiments), and/or the graphics subsystem 548 may be coupled via one or more input/output (I/O) buses. According to some embodiments, the non-transitory computer-readable medium device(s) 546 are portable. According to some embodiments the non-transitory computer-readable medium device(s) 546 are not portable.

The mass storage device(s) 540 may include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. According to some embodiments, the mass storage 540 can comprise RAM and/or ROM. According to some embodiments, the mass storage device(s) 540 can comprise any sort of memory mentioned herein and/or any other suitable type of memory. According to some embodiments, executable instructions that, when executed by the processor 530 or another component, perform the operations and/or functionality of the system 10 and/or any method(s), process(es), and/or algorithm(s) described herein can be stored on the mass storage device(s) 540. Encoding such executable instructions on the mass storage device(s) 540 may transform the physical structure of the mass storage device(s) 540.

The mass storage device(s) 540 may store one or more operating systems, application programs and program modules, data, or any other information. Additionally or alternatively, according to some embodiments, operating system(s), application program(s) and program module(s), data, or any other information may be stored in any suitable portion of the cyberinfrastructure 500 including, but not limited to, the main memory 535 and/or the non-transitory computer-readable medium device(s) 546. Mass storage may be part of, or connected to, the cyberinfrastructure computer 500. The mass storage 540 may also be part of one or more other computing machines that are in communication with the cyberinfrastructure 500, such as servers, database servers, cloud storage, network attached storage, and so forth.

According to some embodiments, the non-transitory computer-readable medium device(s) 546 can operate to input and/or output data and code to and from the cyberinfrastructure 500. According to some embodiments, the non-transitory computer-readable medium device(s) 546 can operate in conjunction with a nonvolatile portable storage medium, such as, for example, a compact disc read only memory (CD-ROM), to input and/or output data and code to and from the cyberinfrastructure 500. In some embodiments, the software for storing information and/or for executing functionality of the system 10 may be stored on a portable storage medium and may be inputted into the cyberinfrastructure 500 via a portable storage medium device such as the non-transitory computer-readable medium device(s) 546.

Peripheral device(s) 542 may include any type of computer support device, such as, for example, an input/output (I/O) interface configured to add additional functionality to the cyberinfrastructure 500. For example, peripheral device(s) 542 may include a network interface card for interfacing the cyberinfrastructure 500 with a network 539.

Input control device(s) 544 provide at least a portion of the user interface for a user of the cyberinfrastructure 500. Input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. Nonlimiting examples of input and/or output devices that could be included as part of the input control device(s) 544 include, but are not limited to, computer mice, keyboards, touchscreens, knobs, dials, switches, buttons, speakers, microphones, printers, LIDAR, RADAR, etc.

To display textual and graphical information, the cyberinfrastructure 500 may include a graphics subsystem 548 and/or a display 549. The display 549 can act as an input and/or output device. More particularly, the display 549 can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), a cathode ray tube (CRT) display, a touchscreen display, etc. The graphics subsystem 548 can receive textual and graphical information and process the information to output the information via the display 549. According to some embodiments, input(s) received by the graphics subsystem 548 and/or display 549 can then be processed by the processor 530 to control operational aspects of the system 10 or other aspect(s) thereof and/or another device.

The cyberinfrastructure 500 may operate in a networked environment using logical connections through the network 539 to one or more other systems or computing machines across the network 539. The network 539 may include wide area network(s) (WAN), local area network(s) (LAN), neighborhood area network(s) (“NAN”), home area network(s) (“HAN”), personal area network(s) (“PAN”), intranets, the Internet, wireless access networks, wired networks, mobile networks, telephone networks, optical networks, and/or combinations thereof.

The network 539 may be packet switched, circuit switched, of any topology, and may use any communication protocol including, but not limited to, Wi-Fi, Bluetooth, ZigBee, near field communication (“NFC”), etc. Communication links within the network 539 may involve various digital and/or analog communication media such as fiber optic cables, free-space optics, waveguides, electrical conductors, wireless links, antennas, radio-frequency communications, and so forth. Communications through the network 539 can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

Each component of the cyberinfrastructure 500 may represent a broad category of a computer component of a general-purpose and/or special-purpose computer. Components of the cyberinfrastructure 500 are not limited to the specific implementations provided herein.

Software embodiments of the example embodiments of the system 10 presented herein may be provided as a computer program product, or software, that may include an article of manufacture on a machine-accessible or machine-readable medium having instructions. For example, according to some embodiments, the executable instructions that, when executed by the processor 530 or another component, perform the operations and/or functionality of the system 10 and/or any method(s), process(es), and/or algorithm(s) described herein can be stored on the non-transitory computer-readable medium device(s) 546. Such executable instructions can be performed/executed via a processor or controller such as the processor 530. The instructions on the non-transitory machine-accessible, machine-readable, or computer-readable medium (such as the non-transitory computer-readable medium device(s) 546 according to some embodiments) may be used to program a computer system or other electronic device. The machine-or computer-readable medium may include, but is not limited to, floppy diskettes, optical disks, CD-ROMs, and magneto-optical disks or other types of media/machine-readable medium suitable for storing or transmitting electronic instructions.

The non-transitory computer readable medium (such as the non-transitory computer-readable medium device(s) 546 according to some embodiments) can operate under control of an operating system stored in memory, such as the main memory 535 and/or the mass storage device(s) 540. The non-transitory computer readable medium can implement a compiler which allows a software application written in a programming language such as COBOL, C++, FORTRAN, or any other known programming language to be translated into code readable by the central processing unit and/or any other type of processor. After compilation, a processor (such as the processor 530 according to some embodiments) can access and manipulate data stored in the memory of the non-transitory computer readable medium using the relationships and logic dictated by the software application and generated using the compiler.

According to some embodiments, the software application and the compiler can be tangibly embodied in the computer-readable medium (which can be the non-transitory computer-readable medium device(s) 546 according to some embodiments). When the executable instructions are read and executed by the non-transitory computer readable medium and/or a processor (which can be the processor 530 according to some embodiments), the non-transitory computer readable medium and/or processor can perform the steps necessary to implement and/or use any aspect(s) of the present disclosure including, but not limited to, any aspect(s) of the system 10. A software application, operating instructions, and/or firmware (semi-permanent software programmed into read-only memory) may also be tangibly embodied in memory and/or other components, thereby making the software application a product or article of manufacture according to the present disclosure.

The techniques described herein are not limited to any software configuration. They may find applicability in any computing or processing environment. The terms “computer-readable”, “machine-accessible medium” or “machine-readable medium” as used herein shall include any medium that is configured for storing, encoding, or transmitting a sequence of instructions for execution by the machine and that can cause the machine to perform any one of the methods, algorithms, and/or processes described herein. It should be noted that the term “computer-readable”, as used herein, can be used interchangeably with terms such as “machine-readable” and/or “machine-accessible”. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

One or more embodiments of the system 10 described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

Portion(s) of the example embodiments of the system 10 may be conveniently implemented by using a conventional general-purpose computer that can be transformed into a special-purpose computer and/or processor when programmed according to the teachings of the present disclosure.

Some embodiments of portion(s) of the system 10 may also be implemented by the preparation of application-specific integrated circuits, field programmable gate arrays, and/or by interconnecting an appropriate network of conventional component circuits.

Dedicated hardware implementations including, but not limited to, application specific integrated circuits, programmable logic arrays, and/or other hardware devices can likewise be constructed to implement the method(s), process(es), and/or algorithm(s) described herein. Applications that may include the apparatus(es) and/or system(s) of various embodiments broadly include a variety of electronic and computer systems. Some embodiments implement functions in two or more specific interconnected hardware modules or devices with related control and data signals communicated between and through the modules, or as portions of an application-specific integrated circuit. Thus, any example system(s) described herein are applicable to software, firmware, and hardware implementations.

In accordance with various embodiments of the present disclosure, the method(s), algorithm(s), and/or process(es) described herein are intended for operation as software programs running on a computer processor. Furthermore, software implementations can include, but are not limited to, distributed processing and/or component/object distributed processing, parallel processing, and/or virtual machine processing.

As noted, some embodiments can include a computer program product. The computer program product may be a storage medium or media having instructions stored thereon or therein which can be used to control, or cause, a computer to perform any of the procedures of the example embodiments of the present disclosure including, but not limited to, the system 10. The storage medium may include, without limitation, a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any computer-readable medium or media, some embodiments include software for controlling both the hardware of the general-purpose and/or special-purpose computer and/or microprocessor, and for enabling the computer and/or microprocessor to interact with a human user or other mechanism utilizing any of the example embodiments of the present disclosure including, but not limited to, the system 10. Such software may include, without limitation, device drivers, operating systems, and user applications. Ultimately, such computer-readable media further includes software for performing example aspects of the disclosure including, but not limited to, the system 10 described herein.

According to some embodiments, included in the programming and/or software of the general-purpose and/or special-purpose computer or microprocessor are software modules for implementing the procedure(s), method(s), process(es), algorithm(s), and/or model(s) described herein.

According to some embodiments, AI can be used in one or more aspects including, but not limited to, the AI widget 18, story generation (such as the story generation feature 48 and/or the story generation feature 148), and/or story editing. While AI has many definitions, some have defined AI as utilizing machines and/or systems to mimic human cognitive ability such as decision-making and/or problem solving. AI has additionally been described as machines and/or systems that are capable of acting rationally such that they can discern their environment and efficiently and effectively take the necessary steps to maximize the opportunity to achieve a desired outcome. Goals of AI can include, but are not limited to, reasoning, problem-solving, knowledge representation, planning, learning, natural language processing, perception, motion and manipulation, social intelligence, and general intelligence. AI tools used to achieve these goals can include, but are not limited to, searching and optimization, logic, probabilistic methods, classification, statistical learning methods, artificial neural networks, machine learning, and deep learning.

According to some embodiments, machine learning can be used in one or more aspects. Machine learning is a subset of artificial intelligence. Machine learning aims to learn or train via training data in order to improve performance of a task or set of tasks. A machine learning algorithm and/or model can be developed such that it can be trained using training data to ultimately make predictions and/or decisions. Machine learning can include different approaches such as supervised learning, unsupervised learning, semi-supervised learning, reinforcement learning, and dimensionality reduction as well as other types. Supervised learning models are trained using training data that includes inputs and specific outputs. This type of training data can be referred to as labeled data wherein the output provides a label for the input. The supervised learning model will be able to develop, through optimization or other techniques, a method and/or function that is used to predict the outcome of new inputs. Unsupervised learning models take in data that only includes inputs and engage in finding commonalities in the inputs such as grouping or clustering of aspects of the inputs. Thus, the training data for unsupervised learning does not include labeling and/or classification. Unsupervised learning models can make decisions for new data based on how alike or similar it is to existing data and/or to a desired goal. Examples of machine learning models include, but are not limited to, artificial neural networks, decision trees, support-vector machines, regression analysis, Bayesian networks, and genetic algorithms. Examples of potential applications of machine learning include, but are not limited to, image segmentation and classification, ranking, recommendation systems, visual identity tracking, face verification, and speaker verification.

According to some embodiments, deep learning can be used in one or more aspects. Deep learning is a subset of machine learning that utilizes a multi-layered approach. Examples of deep learning architectures include, but are not limited to, deep neural networks, deep belief networks, deep reinforcement learning, recurrent neural networks, and convolutional neural networks. Examples of fields wherein deep learning can be successfully applied include, but are not limited to, computer vision, speech recognition, natural language processing, machine translation, bioinformatics, medical image analysis, and climate science. Deep learning models are commonly implemented as multi-layered artificial neural networks wherein each layer can be trained and/or can learn to transform particular aspects of input data into some sort of desired output.

Therefore, as understood from the present disclosure, the system 10, cyberinfrastructure 500, and any other apparatus(es), system(s), and/or method(s) described herein provide an AI-assisted writing platform to Veterans wherein said writing platform is private, said platform can be received, accessed, applied, performed, and/or completed from a convenient location for the user (such as the user's home), said platform can be received, accessed, applied, performed, and/or completed at any time of convenience for the user, and wherein said platform is effective in assisting Veterans to write about their military experience. Additionally, by including the AI widget, the apparatus(es), system(s), and/or method(s) described herein provide the ability for a user to better answer the questions presented. For instance, a user can use the AI widget to perform background research and/or provide additional context when answering the questions presented. Thus, the AI widget increases the quality of a user's responses to the questions presented. The AI widget also increases the speed and efficiency in which a user can answer said questions because the user does not need to conduct separate research outside of the writing platform system 10 in order to provide thorough, accurate, and/or contextual responses to the questions presented. Additionally, the fact that the AI widget reduces and/or eliminates the need to conduct outside research not only speeds up the writing process but also allows the user to avoid having to perform time-consuming, cumbersome, and/or expensive outside research. Further, by assisting a user in writing about their service, the apparatus(es), method(s), and/or system(s) described herein can help Veterans manage challenges related to trauma and/or grief such as mental health struggles including, but not limited to, suicidal thoughts and/or actions, substance usage and/or abuse, PTSD, anger, and the like. Even further, by providing the ability for Veterans to quickly and easily publish a story/blog post on the World Wide Web, the apparatus(es), method(s), and/or system(s) described herein provide the ability for Veterans to preserve their story/blog post forever. Also, by providing the ability for Veterans to quickly and easily publish a story/blog post on the World Wide Web, the apparatus(es), method(s), and/or system(s) described herein provide the ability for such published stories/blog posts to be accessible by a large audience. It can be therapeutic for Veterans to read about the experiences of other Veterans. Thus, by providing the ability for Veterans to publish their stories/blog posts wherein such stories/blog posts can be seen by other Veterans, the apparatus(es), method(s), and/or system(s) described herein can help other Veterans who read the published stories/blog posts manage challenges and/or conditions related to trauma and/or grief such as mental health struggles including, but not limited to, suicidal thoughts and/or actions, substance usage and/or abuse, PTSD, anger, and the like. Even further, by providing an Al widget that can provide emotional support and/or advice, the apparatus(es), method(s), and/or system(s) described herein increase the safety of users and can reduce dangerous, and even life-threatening, situations. Additionally, the apparatus(es), system(s), and/or method(s) described herein allow a Veteran to achieve recognition by publishing a story regarding his or her military service.

It is understood that the apparatus(es), system(s), and/or method(s) of the present disclosure, while primarily directed to U.S. Veterans, can be adapted for use by other groups or classes of people having similar needs as Veterans. For example, any individuals who have suffered trauma, injury, or loss and need emotional support can utilize the apparatus(es), system(s), and/or method(s) of the present disclosure. These groups/classes may include, but are not limited to, abuse victims, recovering users of drugs, alcohol, and/or other substances, car accident victims, athletes with significant sports injuries, foster children, family and friends of murder victims, survivors of mass shootings (including, but not limited to, school shootings), people with a terminal illness, immigrants, refugees, people who are divorced, and/or those who suffer from PTSD. The questions and/or categories of any of the apparatus(es), system(s), and/or method(s) described herein can be modified for various groups and/or individuals who use aspect(s) of the present disclosure to create stories.

From the foregoing, it can be seen that the present disclosure accomplishes at least all of the stated objectives.

What is claimed is:

1. A system for writing assistance, the system comprising:
a processor;
a memory unit and/or non-transitory computer-readable medium that stores executable instructions that, when executed by the processor, perform operations, the operations comprising:
prompting a user with one or more questions;
allowing the user to submit a response to each of the one or more questions; and
allowing the user to access an AI widget to perform research in substantially real time to assist in submission of the response(s) to each of the one or more questions.

2. The system of claim 1, wherein the operations further comprise consolidating and providing a consolidated copy of each of the one or more questions and each response to the one or more questions.

3. The system of claim 2, wherein the operations further comprise allowing the user to email the consolidated copy to a customizable email address.

4. The system of claim 2, wherein the operations further comprise:
allowing a user to upload the consolidated copy and/or upload a photograph; and
providing confirmation of said upload to the user.

5. The system of claim 4, wherein the operations further comprise creating a blog post based on the uploaded consolidated copy and the uploaded photograph.

6. The system of claim 5, wherein the operations further comprise creating a book based on the blog post and/or the consolidated copy.

7. The system of claim 1, wherein the system allows the user to submit a response to each of the one or more questions via text input and/or voice input.

8. The system of claim 1, wherein the AI widget is configured to allow the user to prompt the widget wherein the widget then responds to the user.

9. A method of providing writing assistance, the method comprising:
prompting a user with one or more questions;
allowing a user to respond to each of the one or more questions; and
allowing the user to access an AI widget to perform research in substantially real time to assist in submission of a response to each of the one or more questions.

10. The method of claim 9, wherein the method is for use by United States military Veterans.

11. The method of claim 9, further comprising consolidating and providing a consolidated copy of each of the one or more questions and each response to the one or more questions to the user.

12. The method of claim 11, further comprising allowing the user to email the consolidated copy to a specifiable email address.

13. The method of claim 11, further comprising:
allowing a user to upload the consolidated copy and/or upload a photograph; and
providing confirmation of said upload to the user.

14. The method of claim 13, further comprising creating a blog post, with AI assistance, based on the uploaded consolidated copy.

15. The method claim 9, wherein the step of allowing the user to respond to each of the one or more questions can be accomplished by the user via text input and/or voice input.

16. The method of claim 9, further comprising allowing the user to create a private, secure, and anonymous account of which the user can login and logout.

17. The method of claim 9, wherein the AI widget is configured to allow the user to prompt the widget wherein the widget then responds to the user.

18. The method of claim 9, wherein the AI widget is configured to provide emotional support and/or advice to the user.

19. The method of claim 9, wherein the method is computer-implemented.

20. A computer-implemented method for assisting Veterans, the method comprising:
displaying one or more questions via a display such that the one or more questions are viewable by a user;
allowing the user to submit a response to each of the one or more questions;
allowing the user to provide input to an AI widget to assist the user in submission of at least one response to at least one of the one or more questions; and
providing a therapeutic benefit to the user based on the one or more questions and response(s) thereto and/or based on the user's input to the AI widget.

21. The method of claim 20, wherein the therapeutic benefit comprises recognizing an indication that the user is experiencing and/or has experienced a challenge, based on the response to at least one of the one or more questions and/or on the input provided to the AI widget, and providing output via the AI widget regarding the challenge.

22. The method of claim 21, wherein the challenge comprises suicidal thought(s), PTSD symptom(s), substance usage issue(s), and/or anger, and/or any combination thereof.

23. The method of claim 21, wherein the output comprises guidance, advice, and/or emotional support.

24. The method of claim 23, wherein the guidance, advice, and/or emotional support is related to suicide prevention.

25. The method of claim 20, wherein the therapeutic benefit comprises generating and publishing a story based on the one or more questions and the response(s) thereof.
